(19) United States
(12) Patent Application Publication
(10) Pub. No.: US 2015/0254219 A1
(43) Pub. Date: Sep. 10, 2015

(54) METHOD AND SYSTEM FOR INJECTING CONTENT INTO EXISTING COMPUTERIZED DATA

(71) Applicant: Adincon Networks LTD, Oranit (IL)

(72) Inventor: Amir HAREL, Berlin (DE)

(21) Appl. No.: 14/475,240

(22) Filed: Sep. 2, 2014

Related U.S. Application Data
(60) Provisional application No. 61/948,046, filed on Mar. 5, 2014.
(60) Provisional application No. 61/948,054, filed on Mar. 5, 2014.
(60) Provisional application No. 61/991,867, filed on May 12, 2014.

(51) Int. Cl. G06F 17/24; G06F 17/22; G06F 17/21

(52) U.S. Cl. CPC G06F 17/24; G06F 17/211; G06F 17/2294

(57) ABSTRACT

A computer-implemented method for recording content portions identified within webpages generated by each of a population of legacy websites, including, for at least one individual webpage: identifying content portions of the individual webpage, using a processor for analyzing the content portions to determine at least one characteristic thereof other than portion location, and storing in a computerized database, in association with the individual webpage, an indication of each of the content portions, including a function of the at least one characteristic.

### REFERENCE TO CO-PENDING APPLICATIONS

Priority is claimed from U.S. provisional application Nos. U.S. 61/948,046, entitled “HTML Elements Digital Signature” and U.S. 61/948,054, entitled “Determining Advertising Placement Based on Page Hot Spot”, both filed by Amir Hard on 5 Mar. 2014 and from U.S. 61/991,867 “Method and system for injecting content into existing computerized data”, filed by Amir Hard on 12 May 2014.

### FIELD OF THIS DISCLOSURE

The present invention relates generally to generation of digital content and more particularly to injecting content into webpages.

### BACKGROUND FOR THIS DISCLOSURE

Conventional technology constituting background to certain embodiments of the present invention is described in the following publications inter alia:

### BACKGROUND

Ex post facto injection of content into existing content web pages is commonplace. The injected content can be placed close to the content (e.g. before the content, after the content, or aside the content).

Banner blindness means that most of the focus of the eyes of the readers are on the existing content and not on the injected content, causing low performance for the injected content.

Content today is rich in media (text, images, videos & interactive apps).

Content is currently dynamic, in the sense that content may fluctuate e.g. based on web-initiated updates and/or user interactions, and/or may be rendered differently on different devices.

The disclosures of all publications and patent documents mentioned in the specification, and of the publications and patent documents cited therein directly or indirectly, are hereby incorporated by reference. Materiality of such publications and patent documents to patentability is not conceded

### SUMMARY OF CERTAIN EMBODIMENTS

In order to find the most effective place within the existing content to place injected content, it is therefore sought to analyze content in a manner independent of the rendering of the content. For example, a heat map based on mouse movements and pixel tracking on the web may not be valid if the same page is rendered on a mobile device, or if the user selects to increase the font size, or even if the content owner inserts an image or adds some text.

Certain embodiments seek to provide an injected content insertion system defining and utilizing attention based elements e.g. webpage portions.

Certain embodiments seek to provide a method for collecting data about elements (paragraphs, images, videos) in a media file to rank the most attractive elements in each media and insert injected content adjacent e.g. above/below/atop attractive elements.

Certain embodiments seek to provide a method that works on the elements level to find which elements get the most eyeballs, and insert injected content close to these elements, regardless of the way the page is rendered. It is also possible to measure the performance of injected content inserted in the page in connection to the closest content elements they are inserted to, and to find the injected content location in the page which generates the most clicks, based on closeness to content elements.

Certain embodiments seek to provide a system operative to gather statistics/data from users who scroll a site and/or to use the gathered data in order to find hot elements and inject contents accordingly.

Certain embodiments seek to provide digital signatures for content elements which are accurate and tolerant to page changes. A conventional approach may employ xpath but this might not tolerate different devices or changes to a webpage.

Certain embodiments seek to ensure that the injected content inside content pages are located close to, e.g. at or around, the most attractive e.g. visible and/or effective elements in the page.

Certain embodiments seek to provide methods and devices to insert injected content based on elements visibility data inside the content.

The system may collect click statistics about each injected content placement in order to see which is the more effective and may store most affective injected content locations. For example the system may identify the top 6 (say) hot elements and for each of user groups 1, 2 inject injected content in 3 of the 6 locations. Click rates for each location are recorded and a higher rank goes to those location's associated with better clicks.

Typically, only a single data log is provided per media file, regardless of how the media file is rendered and on which device the file is rendered. In contrast, when heat maps are used, if the webpage changes even slightly, e.g. an image is added or removed, the heat map becomes invalid, and content is injected in the wrong places.

An advantage of certain embodiments is that conventional heat maps find segments which are hot but such segments might include more than one element (images, paragraphs, videos), and the heat map does not know which is the hottest. In contrast, certain embodiments herein do rank the hottest elements thereby to more accurately identify locations for content injection.

An advantage of certain embodiments is that dynamic pages can be handled. If certain pages have dynamic content which is revealed responsive to a click, certain embodiments of the present invention recognize whether or not an element is being displayed, and insert content accordingly.

The following terms may be construed either in accordance with any definition thereof appearing in the prior art literature or in accordance with the specification, or as follows:

The term “closeness” may be defined suitably depending on the application. For example, “close” may be used to mean “within reader's field of view” e.g. injected content is injected close enough to an attractive content element e.g. article being read, such that when a user reads the article (focuses on the content element), the injected content also becomes visible, since it is within the field of view.

The term “content element” or “content item” or “content portion” is intended to include any object (e.g. image, video, or text unit such as article or section thereof or paragraph or heading therewithin) in a document represented for recognition by a browser using a pre-defined, typically computer-platform-neutral and/or computer-language-neutral, interface. For example, the Document Object Model (DOM) is currently an extremely prevalent platform- and language-neutral interface for representing and interacting with objects in HTML, XHTML and XML documents. “The Document Object Model allows programs and scripts to dynamically access and update the content, structure and style of documents. Each object in the DOM tree is termed herein a “DOM element” and content elements, items or portions may each include a DOM element or one or more adjacent DOM elements. However, it is appreciated that embodiments of the present invention would also be applicable, mutatis mutandis, to interfaces other than DOM, which might be developed for representing and interacting with objects in documents such as but not limited to HTML, XHTML and/or XML documents, including allowing programs and/or scripts to dynamically access and/or update content, structure and/or style of at least one document. Such interfaces might share some but not all of the characteristics of the DOM interface. Each content element, item or portion might then include an element, or one or more adjacent such elements, of a suitable interface other than DOM. The term “Content portions” or content elements is typically not intended to refer to trivial partitioning of a website page such as dividing a website page into pixels or alphanumeric characters therewithin, or row thereof.

“children”—A DOM (say) element including content elements such as text or video may have children. For example, a text content element <p> could have children elements like <a><span><strong> or any other tag the developer chooses. A video content element may be wrapped in an <object> tag which often has child elements which provide more information about the video itself. DOM (Document Object Model) represents documents using a tree structure thereby to define nodes which are “children” of other nodes.

“Injected content”: content to be added to an existing webpage. It is appreciated that the methods herein are suitable for injecting any suitable content item such as but not limited to: exhortations to perform an action for maintaining safety of at least one of: equipment, humans and data; news flashes; advertisements; reminders pre-defined by a human user or community of users; ergonometric information; updates pertaining to new voice, text or media messages (emails, SMS, etc.) received by the human user on other systems; jokes and entertainment; and content recommendation e.g., references to articles and/or media files that the user might wish to access.

“Performance” may refer to the number of clicks on an item of injected content close to a particular content element. More generally, performance is the extent of interaction (e.g. as accumulated by a performance counter or engagement counter) with injected content e.g. number of times the user played the injected content, if video. High performance speaks well for the decision to inject content at its current location within the webpage rather than in other locations.

“Reverse method”: Given a digital signature, find a content element e.g. in a webpage having a digital signature which is similar to the given digital signature; this is the “reverse” of generating a digital signature for a given content element. For example, given a stored digital signature which is known to characterize a content element found on a first webpage, find a corresponding content element having a digital signature as similar as possible to the given digital signature, on a second webpage which may be an update or differently rendered version of the first webpage.

Signature or “digital signature”: content portions are identified within webpages generated by each of a population of legacy websites, and analyzed to determine at least one characteristic thereof (e.g. DOM attribute) other than portion location. The signature is then an indication of an individual content portion, comprising a function of the characteristic/s such as a hash of the DOM attributes or a unity function thereof e.g. the content portion attributes themselves. The signature serves to identify content elements uniquely within a web page including within a variation (e.g. updated or differently rendered version) of the webpage in which content element/s are still recognizable by humans.

“Text content” of an element: the actual text inside the tag including its child text. Text content can for example be extracted by removing all tags from the DOM element's inner html attributes using some regular expression or any other method that allows to extract a DOM element text content (for example jquery.text( )). It is appreciated that images are elements which lack both text content and children.

“Visibility” is the extent to which a portion of a website page attracts visitors, e.g. as measured by eyeball tracking or presence of user input device e.g. mouse. “Attractive” is intended to include popular, most viewed, peak interest and hot webpage elements; the term “hot” being used in the sense of heat maps which indicate portions of a webpage which are attractive to (e.g. are accessed or interacted with, by) visitors.

Typically, it is desired to gain maximal exposure for injected content, by placing the injected content close to attractive content already on the webpage. For example, if the injected content is within the field of view of a user who is scanning attractive content, the user may perforce be exposed to the injected content as well.

Placing injected content close to the most attractive elements in the page increases the time the injected content is visible to the user and therefore increase the click through rate (CTR), hence exposure of the injected content.

Example embodiments include:

i. In the Internet, content pages are a collection of HTML DOM Elements (the “elements”). Usually the content is a collection of text elements, image elements and video elements. This method is designed to find the content elements which gets the most eyeballs in time units (“hot spot”) and according to a given injected content inventory, inject the optimal injected content as close as possible to the hot spots.

When given a collection of content elements (text, images and videos) the method counts for each element the number of milliseconds it stays in the main center area of the screen. This data is sent to a remote server which aggregates all the data into a single score for each element. When a user visit a page, the server provides for each content element in the page its computed score and the top scored elements are considered as the hot spots in the page.

The system then checks the dimensions (left, top, width, and height) of each element and tries to see, according to the dimensions, if there is an injected content in the inventory which might be fit to be injected close to the hot spot element. In case of a match, the injected content is injected, otherwise the method continues to the next hot spot in the page and iterates on the process once again.

ii. A web page may include HTML DOM (Document Object Model) elements (The “element”). Given an element from a web page, this method may generate a digital signature for this element. The signature is a collection of data that may allow the reverse method to find the original element in a given page regardless of current location, size of the element in the page or regardless of the device which the page is rendered on. Once a digital signature is captured, it is possible to attach information on elements and store this signature and related data in a remote server and find the element in a page based on the signature which is provided from the remote server.

The method works in both ways:

1) For an input, element may output a digital representation of this element (“Signature”).

2) For an input, signature of an element may output the HTML DOM Element in the page.

The signature is a set of several data components which is extracted for the given element. The present invention also typically includes at least the following embodiments:

Embodiment 1. A computer-implemented method for recording content portions identified within webpages generated by each of a population of legacy websites, including, for at least one individual webpage:

identifying content portions of the individual webpage,

using a processor for analyzing said content portions to determine at least one characteristic thereof other than portion location, and

storing in a computerized database, in association with the individual webpage, an indication of each of said content portions, comprising a function of the characteristic/s.

Embodiment 2. A method according to any of the preceding embodiments and also comprising using said indication for identifying said elements on a website page that has been altered.

Embodiment 3. A method according to any of the preceding embodiments wherein the characteristics include at least one attribute which is unique to only one content element in a webpage.

Embodiment 4 A method according to any of the preceding embodiments and also comprising:

identifying webpage elements having a pre-defined criterion from among said elements;

and inserting injected content adjacent said elements having said pre-defined criterion.

Embodiment 5. A method according to any of the preceding embodiments and also comprising for each individual client device within a given group of client devices used to render said individual webpage:

using said indication for identifying said elements on at least said individual website page as rendered by said individual client device and

identifying webpage elements having a pre-defined criterion from among elements identified at said client device and inserting content items adjacent said elements having a pre-defined criterion,

thereby to inject an individual content item at different locations in the individual webpage on different client devices, if elements are identified at different locations at different client devices due to differential rendering of the webpage to accommodate the different client devices.

Embodiment 6. A method according to any of the preceding embodiments wherein said webpage elements having a pre-defined criterion comprise attractive webpage elements.

Embodiment 7. A method according to any of the preceding embodiments wherein said pre-defined criterion comprises a contextual criterion.

Embodiment 8. A method according to any of the preceding embodiments wherein said contextual criterion is defined in terms of presence of pre-selected keywords in webpage elements.

Embodiment 9. A method according to any of the preceding embodiments wherein said function comprises a hash function. It is appreciated that the function could also comprise the unity function in which case the characteristics themselves are stored.

Embodiment 10. A method according to any of the preceding embodiments wherein said content portions are represented for recognition by a browser using a pre-defined interface.

Embodiment 11. A method according to any of the preceding embodiments wherein said pre-defined interface is computer-platform-neutral and/or computer-language-neutral.

Embodiment 12. A method according to any of the preceding embodiments wherein said content portions each comprise at least one DOM element.

Embodiment 13. A method according to any of the preceding embodiments wherein said content portions each comprise exactly one DOM element.

Embodiment 14. A method according to any of the preceding embodiments wherein said content portions each consist of an integer number of DOM elements.

Embodiment 15. A computer-implemented method for injecting content into webpages, the method comprising:

identifying content elements in a first rendering of an individual website page by an individual client device;

using a processor for identifying said content elements in a second rendering of said individual website page by at least one additional client device;

selecting webpage elements having a pre-defined criterion from among said content elements and inserting content items adjacent said elements having a pre-defined criterion,

thereby to systematically inject an individual content item at different locations in the individual webpage on different client devices, if elements are identified at different locations at different client devices due to differential rendering of the webpage to accommodate the different client devices.

Embodiment 16. A method according to any of the preceding embodiments wherein said content portions comprise DOM elements, thereby to define a DOM structure for the individual webpage and said using comprises searching said DOM structure to find at least one candidate element on said individual webpage which has a first DOM element attribute corresponding to a sought-for DOM element, defining said candidate element as the sought-for element if a predetermined success criterion is fulfilled, and otherwise repeating said defining for at least one candidate element on said individual webpage which has a second DOM element attribute which differs from said first DOM element attribute.

Embodiment 17. A method according to any of the preceding embodiments wherein said searching is performed using document.querySelectorAll.

Embodiment 18 A method according to any of the preceding embodiments wherein said predetermined success criterion comprises reaching a threshold which is a percentage of a sum of weights, including a weight for each attribute of the sought-for DOM element, thereby to represent a maximal score of a candidate element which perfectly matches the sought-for DOM element.

Embodiment 19. A method according to any of the preceding embodiments wherein the percentage differs predeterminedly over websites.

Embodiment 20. A method according to any of the preceding embodiments wherein said identifying comprises determining, when a user scrolls the individual webpage, a duration of time during which each individual content portion remains in viewport, until at least one of a next scroll event and a time-out occurs, and storing said duration in association with said function of said individual content portion's characteristics.

Embodiment 21. A method according to any of the preceding embodiments wherein said identifying comprises determining, when a user scrolls the individual webpage, a duration of time during which an input device interacts with each individual content portion, until at least one of a next scroll event and a time-out occurs, and storing said duration in association with said function of said individual content portion's characteristics.

Embodiment 22. A method according to any of the preceding embodiments wherein said content portion has a tree structure including hierarchically related nodes and said storing includes recursively generating digital signatures for each node in said tree structure.

Embodiment 23. A computer program product, comprising a non-transitory tangible computer readable medium having computer readable program code embodied therein, said computer readable program code adapted to be executed to implement a method for recording content portions identified within webpages generated by each of a population of legacy websites, including, for at least one individual webpage:

identifying content portions of the individual webpage,

using a processor for analyzing said content portions to determine at least one characteristic thereof other than portion location, and

storing in a computerized database, in association with the individual webpage, an indication of each of said content portions, comprising a function of the characteristic/s.

Embodiment 24. A system for recording content portions identified within webpages generated by each of a population of legacy websites, including, for at least one individual webpage:

Webpage analysis apparatus for identifying content portions of the individual webpage,

a processor for analyzing said content portions to determine at least one characteristic thereof other than portion location, and

a computerized database operative for storing, in association with the individual webpage, an indication of each of said content portions, comprising a function of the characteristic/s.

Embodiment 25. A system for injecting content into webpages, comprising:

A content element identification subsystem operative for identifying content elements in a first rendering of an individual website page by an individual client device;

a processor for identifying said content elements in a second rendering of said individual website page by at least one additional client device;

content element insertion functionality operative for selecting webpage elements having a pre-defined criterion from among said content elements and inserting content items adjacent said elements having a pre-defined criterion,

thereby to systematically inject an individual content item at different locations in the individual webpage on different client devices, if elements are identified at different locations at different client devices due to differential rendering of the webpage to accommodate the different client devices.

Embodiment 26. A computer program product, comprising a non-transitory tangible computer readable medium having computer readable program code embodied therein, said computer readable program code adapted to be executed to implement a method for injecting content into webpages, the method comprising:

identifying content elements in a first rendering of an individual website page by an individual client device;

using a processor for identifying said content elements in a second rendering of said individual website page by at least one additional client device;

selecting webpage elements having a pre-defined criterion from among said content elements and inserting content items adjacent said elements having a pre-defined criterion,

thereby to systematically inject an individual content item at different locations in the individual webpage on different client devices, if elements are identified at different locations at different client devices due to differential rendering of the webpage to accommodate the different client devices.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to steps of flowcharts, may be performed by at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein e.g. by providing one or more modules in the processor/s to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

FIGS. 1a-1b, taken together, illustrate a process of finding content elements in a web page that are more attractive e.g. get more visibility (also termed herein “attractiveness”), regardless of the way the page is rendered, and injecting additional content into the webpage, as close as possible to these attractive content elements. The method typically includes recording content portions identified within webpages generated by each of a population of legacy websites, including, for at least one individual webpage: identifying content portions of the individual webpage, using a processor for analyzing said content portions to determine at least one characteristic thereof other than portion location, and storing in a computerized database, in association with the individual webpage, an indication of each of these content portions, comprising a function of the characteristic/s. Alternatively or in addition, the method includes injecting content into webpages, including identifying content elements in a first rendering of an individual website page by an individual client device and using a processor for identifying the same content elements in a second rendering of said individual website page by at least one additional client device; and selecting webpage elements having a pre-defined criterion from among said content elements and inserting content items adjacent said elements having a pre-defined criterion, thereby to systematically inject an individual content item at different locations in the individual webpage on different client devices, if elements are identified at different locations at different client devices due to differential rendering of the webpage to accommodate the different client devices. The method of FIGS. 1a-1b, taken together typically comprises some or all of the illustrated steps, suitably ordered e.g. as shown.

FIG. 2A illustrates the digital signature data which is used, e.g. in the data structure of FIG. 2B, to identify an HTML element in a page.

FIG. 2B illustrates content element data used to identify a content element including the content element's digital signature data e.g. as per FIG. 2A, in conjunction with the content element's relevant visibility and performance data within a page.

Prior art FIG. 2C illustrates the basic structure content web pages have in the Internet.

FIG. 3 illustrates an example of ranking and sorting the content element in a website page using the data set array in FIG. 2b and a suitable element finding method e.g. the element finding method described in FIG. 9.

FIG. 4 illustrates a system, servers and modules to insert injected content typically close to elements in the content typically based on the elements' visibility and/or performance.

FIG. 5 is a simplified division of a screen into virtual segments which is useful in performing the virtual segment generation step 630 in the method of FIG. 6.

FIGS. 6 and 7 are simplified flowcharts of methods, typically performed in parallel to each other and to FIGS. 1a-1b, taken together, which allow the system to gather data to be reported to the server for the benefit of other users. The methods of FIGS. 6, 7 typically comprise some or all of the illustrated steps, suitably ordered e.g. as shown. In particular: FIG. 6 is a simplified flowchart illustration of a method which gathers data for visibility of elements, typically in parallel to the element finding method of FIGS. 1a-1b, taken together; and FIG. 7 is a simplified flowchart illustration of a method operative to gather statistics of clicks on injected content already inserted, which is typically performed in parallel to the element finding method of FIGS. 1a-1b, and/or to the visibility data gathering method of FIG. 6. FIGS. 6 and/or 7 may be performed in parallel to the efforts of processes of FIGS. 3, 4 and 9 to insert injected content based on data sent from the server 403.

FIG. 8 is an example of an injected content inventory data structure that module 406 of FIG. 4 may return e.g. when performing FIGS. 1a-1b, step 30.

FIG. 9 is a simplified flowchart illustration of a method for finding elements in the page based on the digital signature 200. The method of FIG. 9 is suitable inter alia for performing step 35 in the method of FIGS. 1a-1b. The method of FIG. 9 typically comprises some or all of the illustrated steps, suitably ordered e.g. as shown.

FIG. 10 is a simplified flowchart illustration of a method for generating the digital signature 200 of FIGS. 2a-2b and is useful for performing step 620 in the method of FIG. 6 and/or step 703 in the method of FIG. 7. The method of FIG. 10 typically comprises some or all of the illustrated steps, suitably ordered e.g. as shown.

FIG. 11 is a simplified flowchart illustration of a method for inserting an injected content into a page using the data set array 210 as returned by the injected content management module 403. The method of FIG. 11 is suitable inter alia for performing step 45 in the method of FIGS. 1a-1b. The method of FIG. 11 typically comprises some or all of the illustrated steps, suitably ordered e.g. as shown.

FIG. 12 is an example of a hierarchical DOM structure.

FIGS. 13A-13b is an example of a content element (FIG. 13a) and a digital signature generated therefor (FIG. 13b), which is useful in understanding the methods of FIGS. 6, 10.

FIG. 14 is a simplified flowchart illustration of a method for text pattern extraction from a content element useful e.g. for generating a text pattern attribute for the content element's digital signature of FIGS. 2a-2b. The method of FIG. 14 typically comprises some or all of the illustrated steps, suitably ordered e.g. as shown.

FIG. 15 is a simplified flowchart illustration of a method for conducting Text pattern attribute comparisons. The method of FIG. 15 typically comprises some or all of the illustrated steps, suitably ordered e.g. as shown.

FIG. 16 is a diagram of an example text used to extract a text pattern.

Methods and systems included in the scope of the present invention may include some (e.g. any suitable subset) or all of the functional blocks illustrated in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

A system and method allowing content to be injected into a web page close to elements which get most visibility and/or highest performance, without being disrupted by a change in the way the page is rendered or in the device the page is rendered on, are now described in detail, along with methods and functionalities useful inter alia in conjunction therewith.

In an embodiment, a method is operative for finding the most attractive e.g.

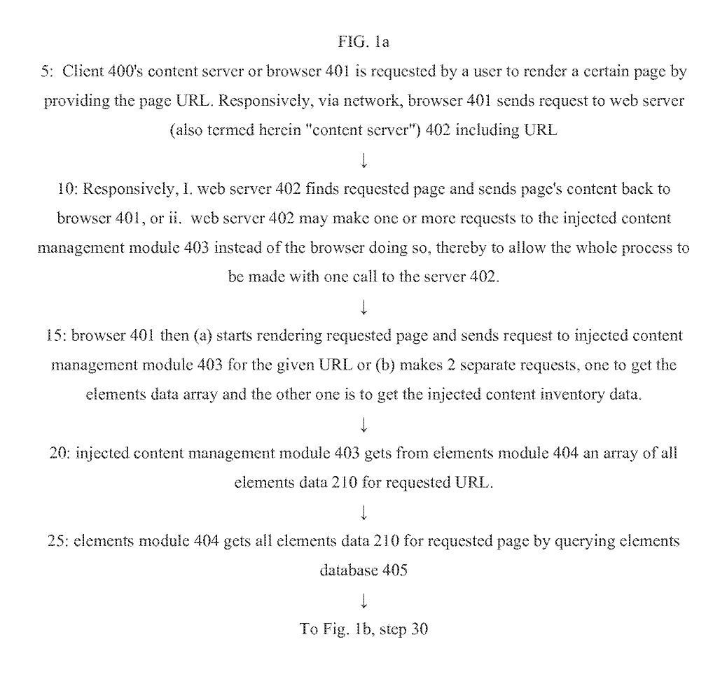

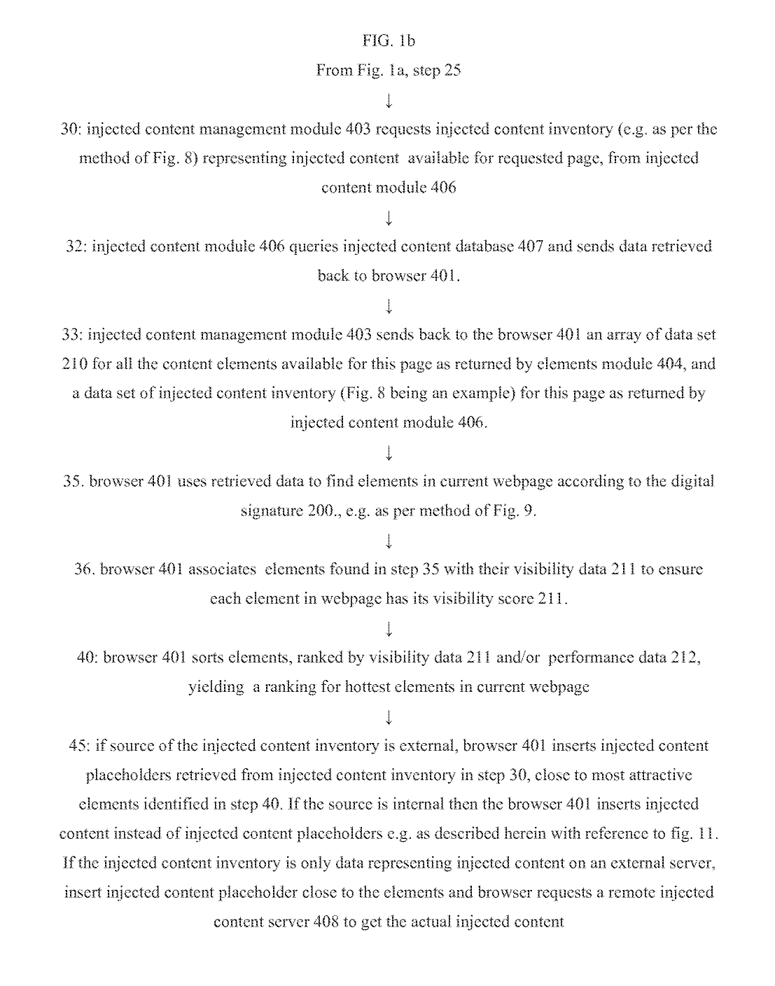

visible elements in a web page and to insert injected content close to them, e.g. as shown in FIGS. 1a-1b.

The method of FIGS. 1a-1b may include some or all of the following steps, suitably ordered e.g. as follows:

5: Client 400's content server or browser 401 is requested by a user to render a certain page by providing the page URL. Responsively, via network, browser 401 sends request to web server (also termed herein “content server”) 402 including URL.

10: Responsively, I. web server 402 finds requested page and sends page's content back to browser 401, or ii. web server 402 may make one or more requests to the injected content management module 403 instead of the browser doing so, thereby to allow the whole process to be made with one call to the server 402.

15: browser 401 then (a) starts rendering requested page and sends request to injected content management module 403 for the given URL or (b) makes 2 separate requests, one to get the elements data array and the other one is to get the injected content inventory data.

20: injected content management module 403 gets from elements module 404 an array of all elements data 210 for requested URL.

25: elements module 404 gets all elements data 210 for requested page by querying elements database 405

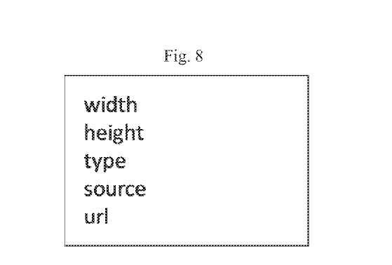

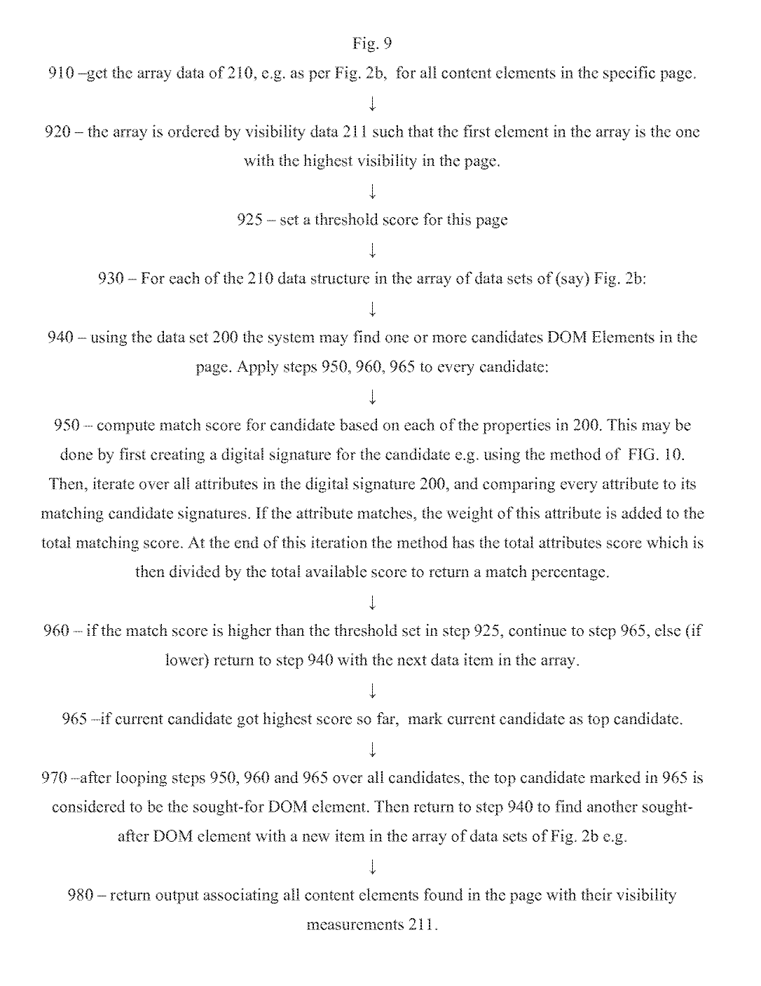

30: injected content management module 403 requests injected content inventory (e.g. as per the method of FIG. 8) representing injected content available for requested page, from injected content module 406

32: injected content module 406 queries injected content database 407 and sends data retrieved back to browser 401.

33: injected content management module 403 sends back to the browser 401 an array of data set 210 for all the content elements available for this page as returned by elements module 404, and a data set of injected content inventory (e.g. as shown in FIG. 8 by way of example) for this page as returned by injected content module 406.

35. browser 401 uses retrieved data to find elements in current webpage according to the digital signature 200, e.g. as per method of FIG. 9.

36. browser 401 associates elements found in step 35 with their visibility data 211 to ensure each element in webpage has its visibility score 211.

40: browser 401 sorts elements, ranked by visibility data 211 and/or performance data 212, yielding a ranking for hottest elements in current webpage

45: if source of the injected content inventory is external (as per data of FIG. 8, e.g.) the browser 401 inserts injected content placeholders retrieved from injected content inventory in step 30, close to most attractive elements identified in step 40. If the source is internal then the browser 401 inserts injected content instead of injected content placeholders e.g. as described herein with reference to FIG. 11. Any suitable e.g. conventional method may be used to insert injected content e.g. the injected content may be inserted to the DOM before or after the content element in the tree using browser DOM manipulation methodology. If the injected content inventory is only data representing injected content on an external server, insert injected content placeholder close to the elements and browser requests a remote injected content server 408 to get the actual injected content.

So, as shown, a request from a user is made (FIGS. 1a-1b, step 5) to a content server. The content server identifies the request and returns the appropriate web page. Then the browser may make a request to an Elements server which may return (FIGS. 1a-1b step 33) an array of per-webpage-element data sets 210 that stores the signature data 200 in order to find the element in the page and the visibility data 211 to understand which element has the highest visibility.

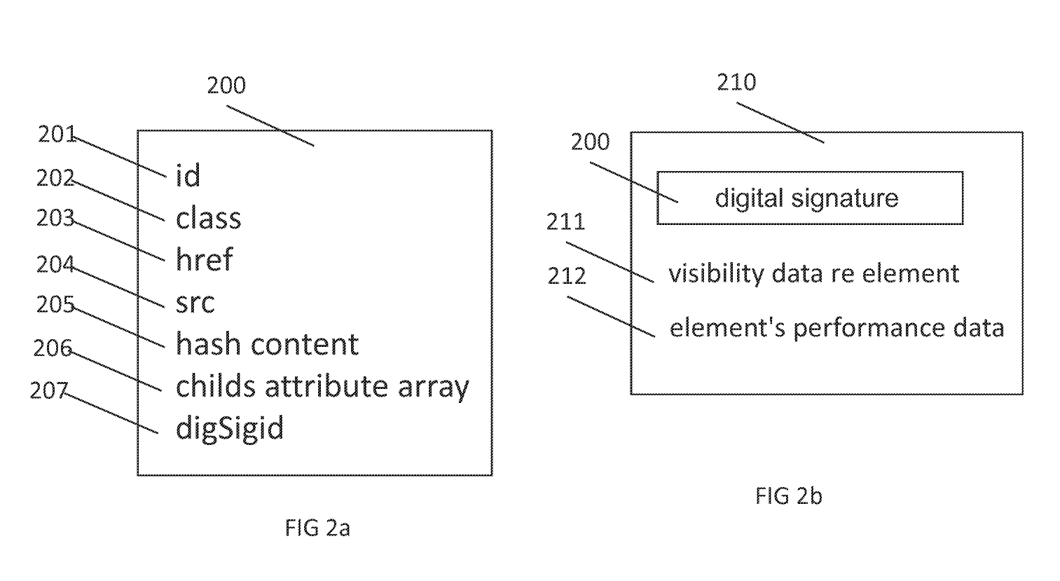

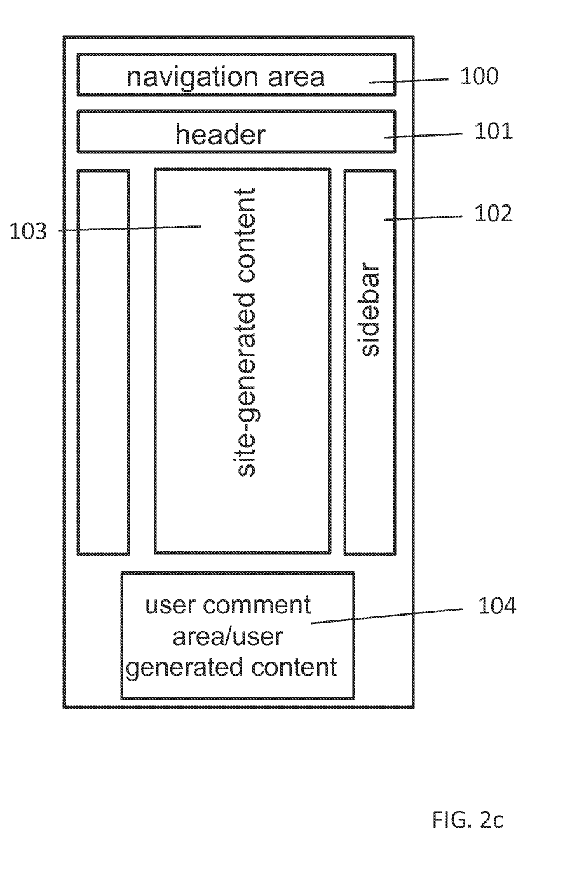

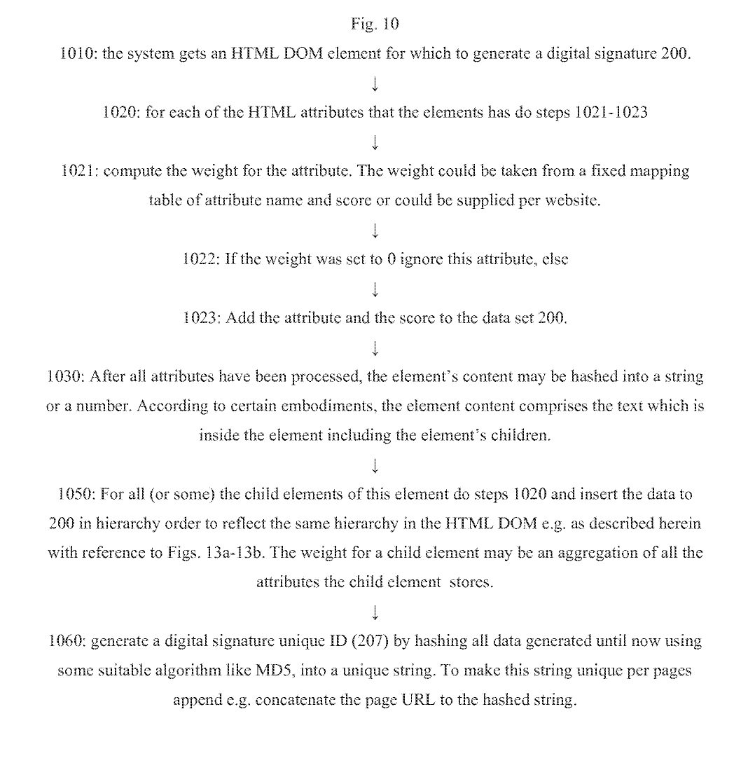

FIG. 2A illustrates the digital signature data which is used, e.g. in the data structure of FIG. 2B, to identify an HTML element in a page. It is appreciated that the example data table set of FIG. 2a, which is typically used by element module 404 and stored in elements database 405, is intended to be an example, and is not intended to be limiting, since the attributes of the DOM element are determined and created differentially by developers of different sites and may also differ between pages in the same site. Digital signature ID 207 is always present, however, according to certain embodiments, it is generated in step 1060 of FIG. 10.

201 is the unique (within the page) (ID attribute) which a webpage programmer may have defined for the element. Elements with this attribute may look like this: <div id=“myid”>. 201 may get a high weight score, e.g. higher than any other attribute, since this ID is typically assigned to only one single DOM element (say) within a webpage.

202 is the class name which was given to this element: <div class=“class1 class2”>. 202 is not very unique in the sense that more than one element in a given page could have the same class and therefore its weight score may be low.

203 and 204 are referred to elements which point to some resource in the Internet using a URL. Since URLs are unique within each given web-page, the weight score for this attribute may be high.

206 is a representation e.g. hash of the actual content an element may include.

Any suitable method may be employed to generate the hash e.g. as described herein with reference to STEP 1030 in FIG. 10.

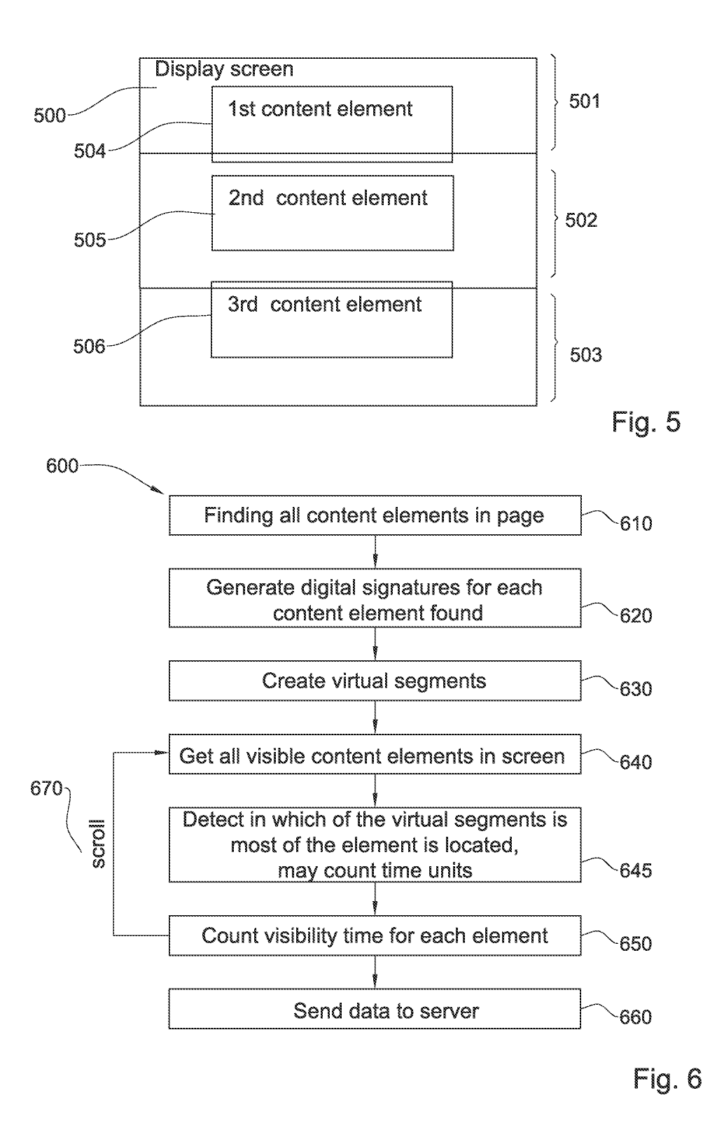

FIG. 2b, then, illustrates content element data used to identify a content element including the content element's digital signature data e.g. as per FIG. 2A, in conjunction with the content element's relevant visibility and performance data within a page. FIG. 2B describes an example data structure to be used to track elements visibility e.g. as per the method of FIG. 6 herein. 210 is a data object storing some or all of the following components: 200 which is the digital signature as described in FIG. 2A above, 211 which is a measurement of the visibility of the element, and performance data 212 which is a measurement of the element performance once an injected content has been placed close to it.

FIG. 2b is a data set storing some or all of the data of 200+211+performance data 212, for one element in one page in one website. An array of this data set may be provided for multiple elements, pages or websites, in a system serving a multiplicity of websites.

The data of FIG. 2b typically includes information about how to find each element in the page regardless of the way and position it is rendered and related information for each element about its visibility measurements, compared to all the other elements in that page. The browser then may find (FIGS. 1a-1b, step 35) the actual DOM (document object model) elements in the page based on the elements array obtained from the server and may sort them (FIGS. 1a-1b, step 40) by their visibility measurement. The code may make another request (FIGS. 1a-1b, step 30) to an injected content server to get an injected content inventory for this page. The code may insert injected content from the inventory provided, as close as possible to the most attractive elements in the page.

According to some embodiments, in step 33 of FIGS. 1a-1b, both the elements array, the injected content inventory and the injected content insertion settings can be returned, either together or in parallel, by the same server at the same time to increase performance of the system and save requests being sent the network.

Content web pages usually have a structure similar to that illustrated in prior art FIG. 2c, e.g. some kind of a navigation area 100, a header area 101, one or two sidebars 102 beside the content, the actual site-generated content 103, and sometimes a comment area 104 in which users can post content e.g. in order to comment upon the site-generated content 103. These areas 100,101,102,103,104 could each comprise one or more HTML DOM elements which generate the area's portion of the screen and may include text, images, videos or any other valid webpage content element e.g. HTML DOM element, that the browser recognizes. 103 and comment area 104 are often the main reason that users revert to content web sites, such as online news sites and magazines, and this is where most of their attention is directed to. 103 and comment area 104 are usually composed of content elements such as text, images and videos. While 100, 101 and 102 are almost the same on all content pages within the same web site, the content areas 103 and comment area 104 differ greatly from one page to another, both in the existing e.g. site-generated content and the number of content items they hold, and the commenting section 104 is dynamic and is constantly being created, as more users engage with the page. 103 and comment area 104 are also more likely to be changed by the site owner; sometimes an image is added or removed from an article, and while comments are always being created, sometimes the owner can remove an inappropriate comment from the page. On mobile versions, due to screen size limitation 102 and sometimes even 100 are not displayed to the user. This means that the same page on different devices may appear differently. Moreover, advanced browsers today allow users to set different rendering settings according to their needs, so the same page could be rendered and look different from one user to another. When content is referred to herein it may include either area 103, 104 or both.

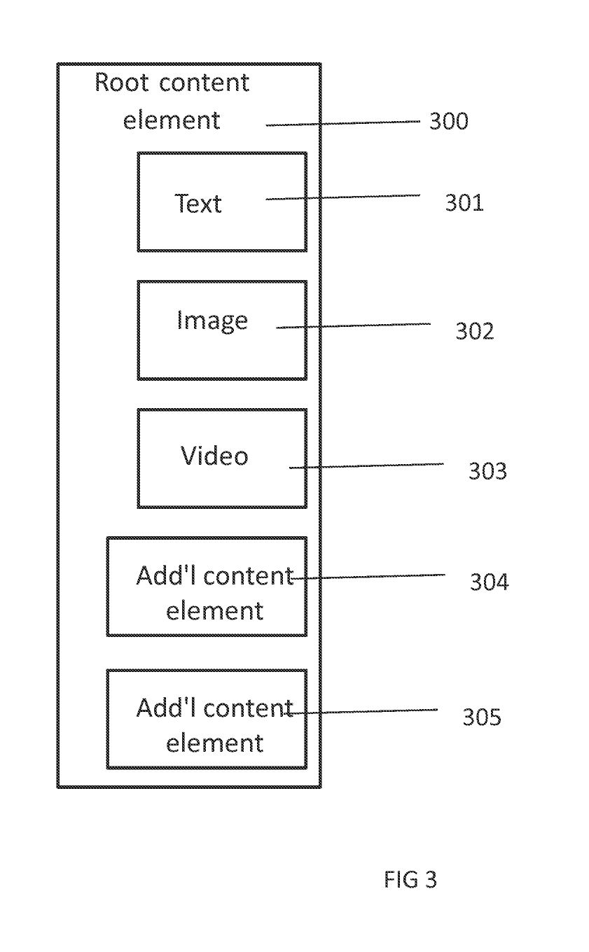

FIG. 3 illustrates an example of ranking and sorting of content element/s in a website page using the data set array in FIG. 2b and a suitable element finding method e.g. the element finding method described below in detail with reference to FIG. 9.

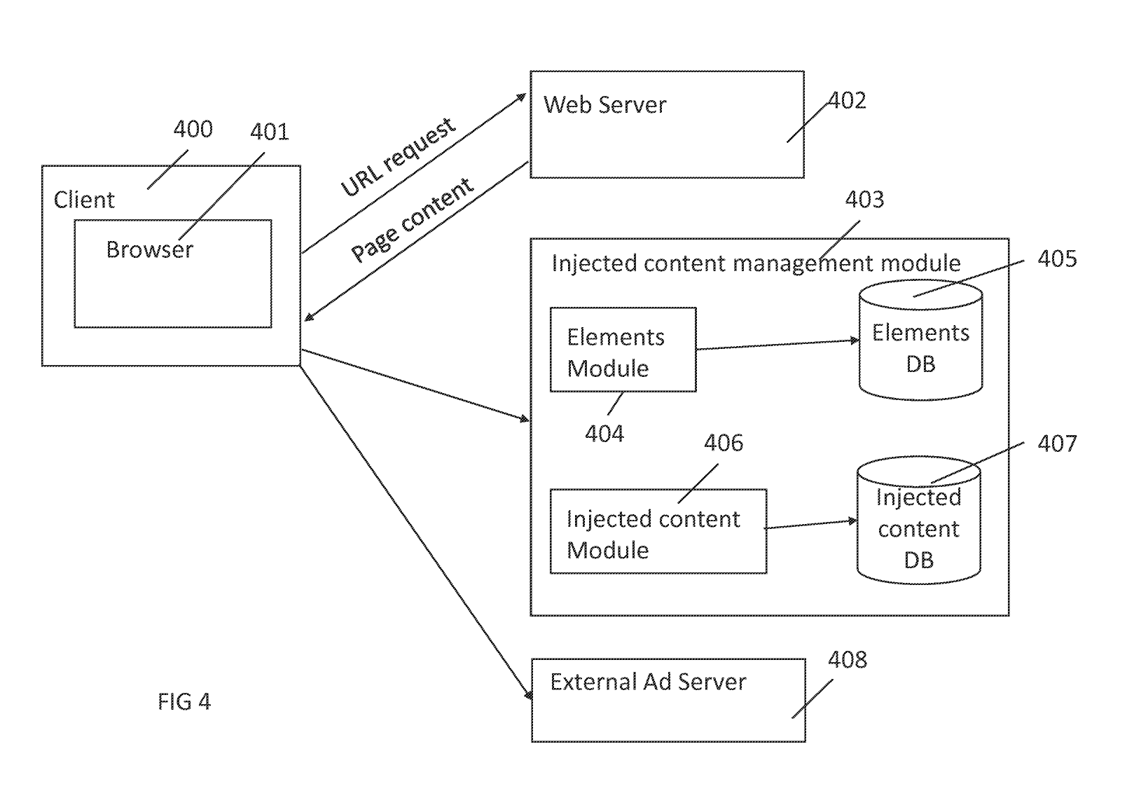

In order to find which content items are getting the most visibility and/or best performance, suitable methods for recognizing content elements may be employed e.g. as described herein. For example, FIG. 4 illustrates a system, servers and modules to insert injected content typically close to elements in the content typically based on the elements' visibility and/or performance. Browser 401 typically performs some or all of the methods of

FIGS. 6, 7, 10, 5 9, 11. Suitable modules and servers, e.g. some or all of those shown and/or described herein, may be provided for storing data and/or aggregating numbers. Injected content module 406, according to certain embodiments, is operative merely for getting inventory data and may not include any processing beyond this.

FIG. 4 describes the system and its modules, server and devices to insert injected content close to content elements with the most visibility and/or performance. Client machine 400 typically includes a software program 401 used to render web pages, also called a browser. The browser 401 is requested to render a certain page by providing the page URL. The browser 401 sends, through the network, a request to a web server 402 by providing the URL. The web server 402 may find the requested page and send back to the browser 401 the page content. The browser 401 may start to render the page and send a request to the injected content management module 403 for the given URL. The injected content management module 403 may get from the elements module 404 an array of all the elements data 210 for the requested URL. The elements module 404 may get all the elements data 210 for this page by querying the elements database 405. The injected content management module 403 may also request from the injected content module 406 an injected content inventory available for this page. The injected content module 406 may query the injected content database 407 and may get an injected content inventory. An injected content inventory could be either the actual injected content or any other data to represent injected content stored on an external injected content server 408. The injected content placement module 403 may send all the retrieved data back to the browser 401. The browser may use the provided data to find the most attractive elements in the page, sort them by their visibility rank and/or performance rank and then may start to insert injected content close to these elements based on the injected content inventory that was provided. If the injected content inventory is only data representing injected content on an external server, the system may insert a content placeholder close to the elements and the browser may make a request to a remote content server 408 to get the actual injected content.

As described herein, browser 401 typically makes one request to the injected content management module 403 and gets the requested data in response. However the system can also work in parallel where the browser 401 requests the elements array from the elements module 404 and sends another request to the injected content module 406 in any sequence the browser 401 wants, e.g. as per FIG. 10, step 10, option b.

In another embodiment the browser 401 may make a request to the web server 402 in order to get the page content. In this case, the web server 402 may find the requested page and then may make a request to the injected content management module 403 to get the elements data and the injected content inventory data. Then the web server 402 may use the data to insert the injected content in the content based on the data obtained from the injected content management module 403. Then the web server 402 may return the page with the injected content inserted already to the browser 401, e.g. as per FIGS. 1a-1b, step 10, option II.

FIG. 5 is an example of division of a screen into virtual segments. This is useful e.g. in performing the virtual segment generation step 630, described below, in the method of FIG. 6.

A system and method to generate the visibility data 211 for all the content elements in a page is now described. FIG. 5 illustrates a display device 500 e.g. screen of a personal computer or mobile device on which a webpage is rendered. Referring now to FIG. 6, step 630, the system divides the screen 500 into virtual segments typically according to the screen size and resolution. For example virtual segments of a screen 501, 502 and 503 may be employed, each comprising a vertical slice of the screen e.g. ⅓ of the height of the screen; and each virtual segment may be given a visibility factor: the more the virtual segment is centered in the screen the higher the visibility factor would typically be, e.g. dependent on the screen size and the amount of virtual segments that were created for the current device. In this example 501 and 503 gets a visibility factor of 1 while 502 gets a visibility factor or weight of 2. For small devices, such as mobile phones, all segments may have equal weights e.g. 1.

When a content element, like a text, image or a video, are detected as attractive in the screen 500, the system may detect (step 645) in which of the virtual segments most of the elements are located and may count time units, e.g. as per STEP 650 in FIG. 6. The method typically computes a sum of whichever elements are considered to be in this virtual segment multiplied by the visibility factor.

For example, the content element 504 is considered to be inside virtual segment 501 since most of its area is inside 501. The system may count the seconds that the element 504 stay in 501 and may multiply that by 1. Element 505, on the other hand, is inside virtual segment 502 and therefore the system may count the number of seconds it stays there and multiply this by 2, since the visibility factor in this example is 2. Element 506 is considered to be inside the virtual segment 503 and the time it spends there may be counted and may be multiplied by 1.

FIG. 6 is a simplified flowchart illustration of a method for collecting content elements' visibility data 211 in FIG. 2b for sending to the server 403, performed by the server in conjunction with module 404 in FIG. 4. It is appreciated that the processes of FIGS. 6 and/or 7 are each typically performed in parallel to the efforts of processes of FIGS. 3, 4 and 9 to insert injected content based on data sent from the server 403.

FIG. 6 may be executed by the browser of FIG. 4 in order to collect and send to the server 403 of FIG. 4, the content data 210. In step 610 a list of all the content elements in the page is obtained; the list may either be provided to the system from an external and independent process or by some markup specification in the HTML to define content elements, or even manually or semi-manually, in conjunction with a human operator. Step 620 may create digital signatures 200 for all the content elements found in 610 e.g. using the method of FIG. 10. 630 may create the screen virtual segments as FIG. 5 described above. 640 may check which of the content elements are now visible in the screen. Step 645 may determine for each visible content element found in step 640, a virtual segment with which the visible content is associated. For example, a content element may be considered to be inside a virtual segment if at least 51% (or other proportion) of it is inside that virtual segment. This criterion is determinable e.g. using known content element dimensions (width and height) and the content element's position in the viewport (screen) relative to the known position of each virtual segment. Once a content element has been associated with a virtual segment, the visibility score to apply in step 650 is also determined Step 650 may count for each visible element the time it is visible in each virtual segment and may apply the visibility factor. The data may be stored in the visibility data 211 for each element. Step 660 may periodically send the array data of 210 which step 650 generates to a remote server where the elements module 404 may process all the data. Whenever a scroll event 670 occurs the system may go back to step 640 and repeat the process for the visible elements which are now in the screen. In FIG. 6 step 630 could be executed in parallel to steps 610 and/or 620; step 630 is typically executed before 640.

Typically, in Step 660, the system repeatedly, e.g. periodically, e.g. each, say, 2 seconds, grabs all content elements whose counters increased in step 650 (e.g. all content elements whose time counter>0), and applies the virtual segment's weight score, if any, to the time counter value. For example if content element 1 was in a virtual segment having a visibility score of 2 and there are 3 seconds in element 1's time counter, and content element 2 was in a virtual segment having a visibility score of 1 for 5 seconds, then the visibility data time for content element 1 is 6 (3*2) seconds and for content element 2—5 (5*1) seconds. This data is stored, for each content element, in visibility data field 211 of FIG. 2b and sent to elements module 404 of FIG. 4; once this is done, the system resets all counters to zero so visibility time may be counted only once.

Typically, the method of FIG. 6 computes how much time each element is visible in the screen, optionally factored by a weight score representing the “centrality” of the element's position in the screen (higher if the element is visible at the screen's center, lower if the element is visible at the screen's periphery). The method may in fact compute the amount of time that a content element is displayed on the screen and/or the amount of time that a user input device e.g. mouse is interacting with e.g. hovering over a content element, e.g. as described herein. In particular:

Referring again to Step 630, this step optionally divides the screen into virtual segments e.g. as described herein with reference to FIG. 5. For example, the screen may be partitioned into several horizontal strips, each also termed herein a “virtual segment”, including or consisting of a top, middle and bottom strip, which may or may not be equal in size (e.g. may each have a height of ⅓ of the screen's height). The number of virtual segments can change from device to device. Weights may be determined as a function of the screen resolution of the device the webpage is currently rendered on, and/or as a function of centrality of the segment. For example, if the device that the webpage is rendered on is a small device, such as a mobile phone, weights may be set to be equal for all virtual segments e.g. the score is 1 for all segments. For devices whose screen resolution is larger than that of a mobile phone, the middle virtual segment/s may have a higher weight than the peripheral segments e.g. the middle strip may have a weight score of 2, whereas the top and the bottom virtual segments may each be assigned a weight score of 1.

Referring again to step 640, this step checks each content element in the web page to determine whether or not it is visible in the viewport (option A). Typically, whether or not an element is visible to a user according to the current scroll is determined by comparing position of the content element in the page, screen resolution and current scroll position. Alternatively or in addition (in parallel e.g.), extent of interaction between user input device and content element may be recorded (option B) e.g. by registering “mouseenter” and “mouseleave” events for content elements.

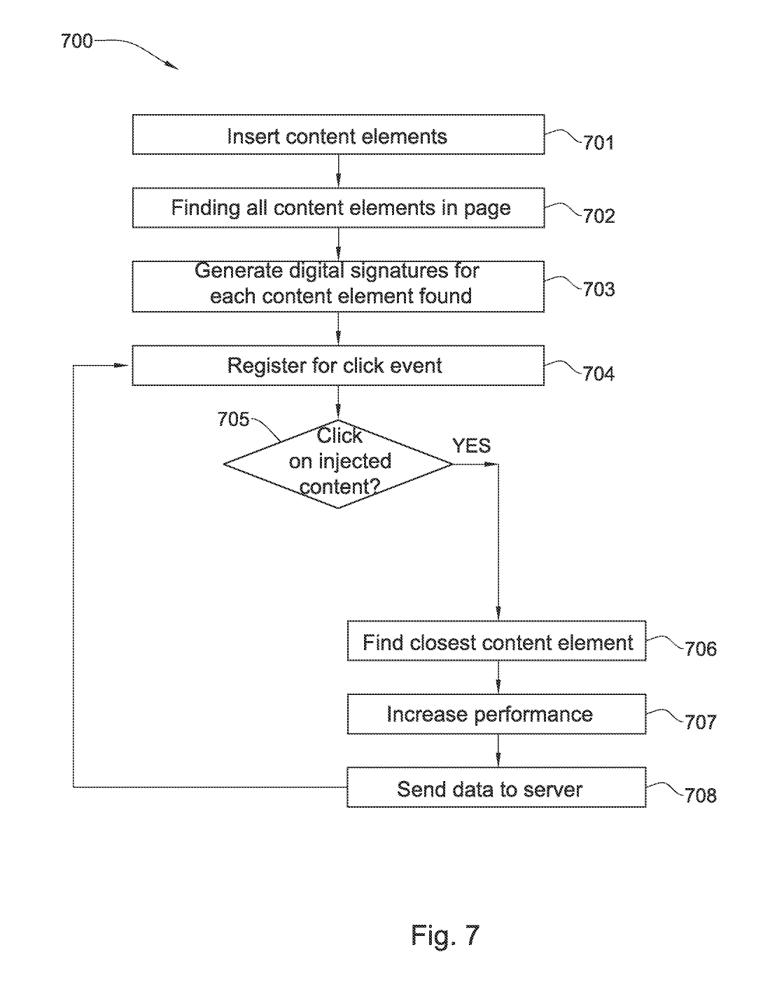

Referring again to Step 650, typically, once a scroll event has occurred, for each content element which is found in step 640 to be visible, the system starts counting the number of milliseconds for which that content element is visible. For example, if the user has stopped scrolling and reads some text for 5 seconds, and then continues to scroll to another area in the page, the content elements that were visible each get a visible counter of 5 seconds. However, the system typically stops counting time for an element which exceeds a predetermined threshold such as, say, 10 seconds, so as to discount cases in which a user keeps the page open in a specific point and goes off to read another page or even leaves her or his computer. Similarly, if option B in step 640 is performed, then when a “mouseenter” event is triggered for a content element the system starts counting the time the mouse is over this element and stops when a “mouseleave” event is triggered or, optionally, when a predetermined threshold is reached. FIG. 7 is a simplified flowchart illustration of a method for collecting content elements performance data 212 in FIG. 2b for sending to the server 403, performed by the server in conjunction with module 404 in FIG. 4. Typically, the method of FIG. 7 is operative to generate the performance data 212 for all the content elements in a page. Typically, injected content has already been inserted to the page by step 701. Step 702 is typically operative to find all content elements in the page. This data may for example be provided to the system from an external and independent process or by some markup specification in the HTML to define content elements or by any other suitable technology, or even by using human intervention. Step 703, e.g. using the method of FIG. 10, may create digital signature 200 for all the content elements found in 702. 704 may register to click events in the page. This may allow the system to get an event from the browser when the user clicks anywhere in the page. 705 is the condition to check when a click event has triggered if the click was made on an injected content in the page. If the click was made on an injected content, module 706 may find the closest content element to this injected content element in the page. 707 may increase the performance of this content element digital signature and 708 may send the content element 210 to a remote server where the elements module 404 may process all the data. Then the system may do the whole process again by going back to 704 and registering for click events. In this description 704 represents a process of registering to a click event in the browser. It is also acceptable to register once to click events without needing to do it again by the end of process 708 as described above since the browser allows to register for events that occur more than once.

In FIG. 7, it may be desired to record the extent of engagement or interaction of users with an item of injected content e.g. how many times the user clicked on the injected content (if link) or played the injected content (if video). Once content has been injected (step 701) and digital signatures for each content element have been generated (step 703), each click event (say) or other engagement with the injected content is registered (704). Each time a click occurs (step 705), the closest content element to the click is identified (step 706) and performance data e.g. counter for that content element is incremented (step 707); the data (counter=1) is then (step 708) stored, for each content element, in performance data field 212 of FIG. 2b and sent to elements module 404 of FIG. 4; once this is done the system resets all counters to zero.

Browser 401 typically allow programmers to register to user and system events, e.g. registration within the browser to click events that occur in each given webpage such that once the user clicks on anything in a particular webpage of interest, the browser 401 (FIG. 4) triggers this event and the system is executed, and checks if the event was triggered due to a click on an “injected content” element. If so, the engagement counter is incremented.

It is appreciated that the methods of FIGS. 6 and 7 are typically each performed for all users and are typically based on e.g. triggered by a suitable event. In FIG. 6 as illustrated, the triggering event is “scroll”, so every time there is a scroll event steps 640, 645 and 650 are performed, typically for all users. The method of FIG. 7, as illustrated, is performed based on e.g. triggered by each click event. Other methods for collecting visibility and/or performance data may be employed, however, which may or may not be triggered as described herein with reference to FIGS. 6, 7.

FIG. 8 is an example of an injected content inventory data structure which the injected content module 406 of FIG. 4 can return e.g. when performing FIGS. 1a-1b step 30; some or all of the fields shown may be provided. The width and height set the injected content dimension. The type could include information about which injected content format it is (display or text or both). The source explains if this is an external injected content (served by an external injected content server) or whether it is an internal injected content. In case this is an internal injected content the url may store info about where the injected content is located, and in case the source is external, the url may be to the external injected content server to get the URL. This is a mere example of the data structure and alternatively, any data structure that represents all the supported injected content for a page may be employed. For example if the injected content includes content recommendation, the inventory data set of FIG. 8 may be different and may for example include some or all of the following fields: 1) title of the article which it is believed the user might like to read, 2) preview image of the article, 3) precis of the article 4) url to the article. If the injected content is a video, the inventory data may for example include some or all of the following fields: width and height of the video, video source (YouTube or Vimeo, or other video platform) video url, video title.

FIG. 9 identifies content elements in a webpage, which may have been modified or rendered on a different device, based on suitable previous analysis of the webpage which may have occurred before the webpage was modified or differently rendered.

Before describing FIG. 9 in detail, reference is made to FIG. 10 which is a simplified flowchart illustration of an example process of generating the digital signature 200 of FIGS. 2a-2b. The method of FIG. 10 may include some or all of the following steps, suitably ordered e.g. as follows:

1010: the system gets an HTML DOM element for which to generate a digital signature 200.

1020: for each of the HTML attributes that the elements has do steps 1021-1023

1021: compute the weight for the attribute. The weight could be taken from a fixed mapping table of attribute name and score or could be supplied per website. For example an attribute called “style” would have a weight of 0 since it only affects how the element is being rendered, and even could be removed later and replaced with a CSS class name without changing the way the elements looks and behave. Attributes which are related mainly to rendering (such as: “align”,“style”,“border”,“width”,“height”,“color”,and “cols”) may get 0 weight (be ignored). The more likely it is that an individual attribute is unique in the page (like: “id”,“src”,“href”) the higher weight that attribute may get. It is appreciated that according to certain embodiments, combinations of elements may be assigned a high weight because while they are not unique individually, they do tend to be unique in combination.

1022: If the weight was set to 0 ignore this attribute, else

1023: Add the attribute and the score to the data set 200.

1030: After all attributes have been processed, the element's content (e.g. text in a <p> element) may be hashed (e.g. using an MD5 algorithm or any suitable hashing algorithm) into a string or a number. According to certain embodiments, the element content comprises the text which is inside the element including the element's children. For example given the following DOM element: <p>hello <span>world</span>2</p> the content of element <p> would be hello world 2, since the content of the child element is also used.

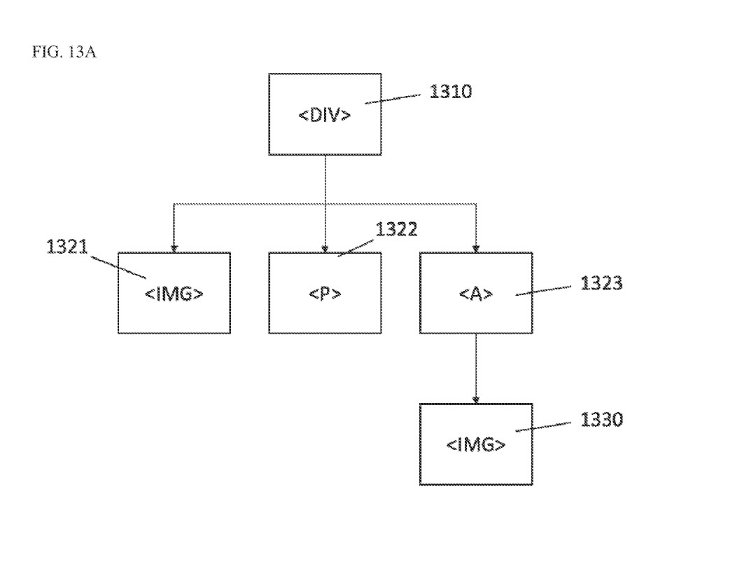

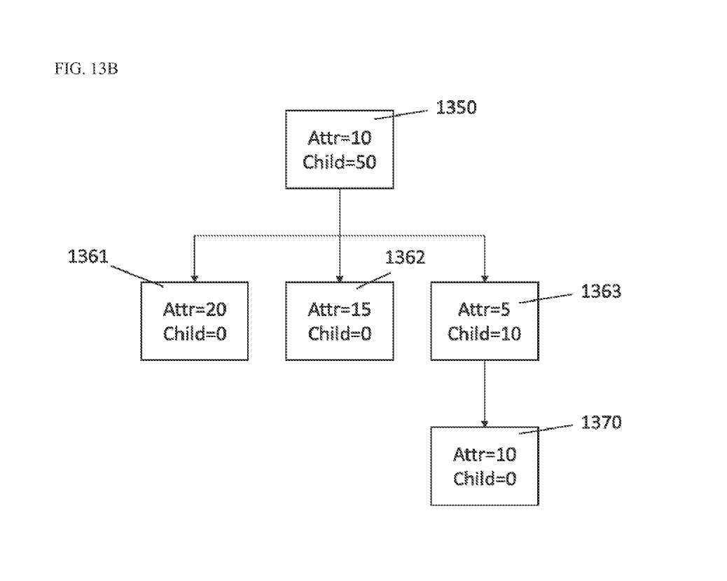

1050: For all (or some) the child elements of this element do steps 1020 and insert the data to 200 in hierarchy order to reflect the same hierarchy in the HTML DOM e.g. as described herein with reference to FIGS. 13a-13b. The weight for a child element may be an aggregation of all the attributes the child element stores.

1060: generate a digital signature unique ID (207) by hashing all data generated until now using some suitable algorithm like MD5, into a unique string. To make this string unique per pages append e.g. concatenate the page URL to the hashed string.

In order to be able to track content elements, the following method may be employed to create a digital signature for every element in the page (e.g. as described herein with reference to digital signature generation step 620 in FIG. 6 and FIG. 10), so it is possible to track the visibility of an element and to be able to find the element in the page back from that digital signature.

When given an HTML document object model (DOM) element, for example a <p>, <div>, or <img> element, the system may extract attributes, e.g. as per FIGS. 2a-2b herein, for the DOM elements which can be used to find the element in the page, regardless of the way that the page is rendered or to the device it is rendered on e.g. by defining some attributes as more important than others, and giving these higher weights, as described herein in detail e.g. with reference to FIG. 10; see e.g. step 1021.

For example, if a digital signature is extracted for a text element <p>, if the page was changed and some images were removed from the page and that <p> element is now in a different position in the page, the digital signature may still allow the method to find the <p> element even if it is in a different location in the page. FIG. 2A shows the attributes which might, for example, be taken from an HTML element in order to create its digital signature.

Referring again to FIG. 2a, therefore, reference numeral 200 represents a machine readable data that stores one or more attributes that can be stored for an HTML element.

The system may give each attribute a weight score e.g. as described in FIG. 10 Step 1021, to reflect its importance in the overall data structure. This may allow the system to be tolerant to changes in the page, in that if one or more of the attributes are no longer relevant, there may be other attributes that may be able to find the element.

For example, one attribute might be assigned a high weight score to emphasize that in case this attribute was not found, it means that the element was not found. For example, in case of an image element <img>, if the “src” attribute was changed, the system typically interprets that this is a different image.

Any or all attributes that the element may have, may be stored, such as but not limited to the attributes in FIG. 2A. While an HTML element could have endless possibilities of attributes since attributes are created by the page developer, FIG. 2A describes common attributes used to create the digital signature.

Not all elements necessarily include content, such as image element <img src=“myimgae.jpg”/>, but usually text elements have content like so: <p>hello world</p>, where the content is “hello world”. For example, item 205's weight score may be low since content can easily change slightly over time (e.g. fixing typos or adding sentences) but this need not be interpreted as meaning that the entire element is no longer existent. Since content could be long, and for ease of comparison, the content is typically extracted and hashed into a number which is unique in the sense that it can be assumed to be at a very high level of confidence that only this content yields this ID whereas any other content yields a different ID. Any suitable e.g. known hashing algorithm may be employed such as md5 or blake hashes, merkle-damgåard (md)-based hashes other than md5, sha hashes, swifft hash and any other known suitable hash function. However, alternatively, text content of 205 may be provided as-is, without any hashing mechanism. The term “text content” is intended to include the text inside a DOM element including its children. Examples of text content:

a. <DIV>CONTENT</DIV>; here the text content is “content”.

b. <DIV>CONTENT <IMG SRC=“MYIMAGE.JPG”/><P>SOME TEXT</P></DIV>; here the text content of the <div> is “content some text” since only the text inside the <div> and its children is relevant.

When the method is ignorant as to where the element is positioned in the page, DOM elements nested inside the element, termed herein child elements, may be employed e.g. as described herein with reference to Step 1050 of FIG. 10. An HTML DOM element could have children elements such as <a href=“about.html”><img src=“about.jpg”/></a>. In this example the <a> element has an <img> child element. 206 is a data array of 200 as described above for all or some of the element's children.

More generally, when the digital signature method gets an element such as a DOM element, a check is typically made to determine whether or not this element has children (e.g. in the DOM tree structure used to represent the webpage of interest), since some elements (<img> elements e.g.) do not have children, such that the children attribute 206 might be empty. If the element does have children, an array digital signature 200 may be generated to represent all children elements of the current DOM (e.g.) element.

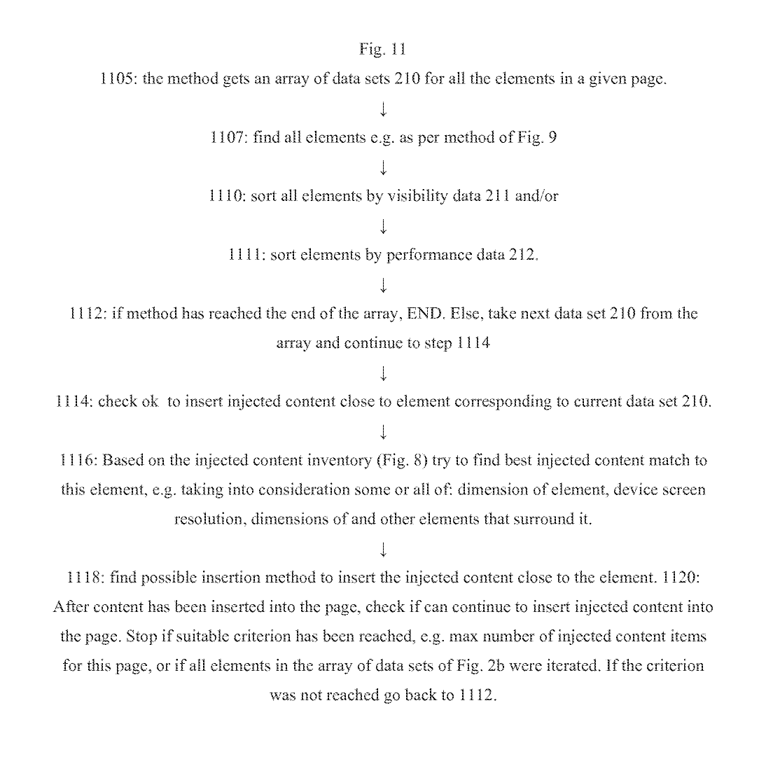

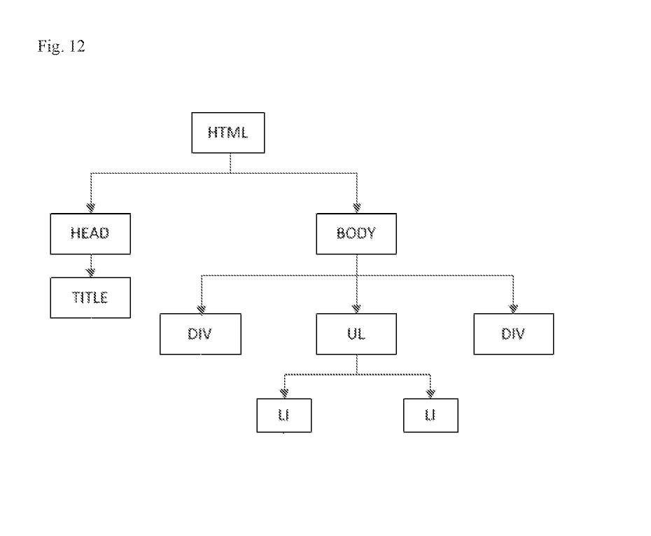

Example: FIG. 12 is a Document Object Model (DOM tree structure in which as shown all elements except the <html> element (root) have a parent element and each element may or may not have one or more children. In the illustrated example, the <body> element has 3 children elements: <div> <ul> and <div>. For example if the element <ul> (in FIG. 12) was given, the method may create an array of 2 digital signatures 200 since this element has 2 children: <li> and <li>. Then the method may call the digital signature method again by providing the first child <li> and storing the result in the first array index. If any of the children elements have children calling typically occurs again and again, this occurs recursively, until the “leaves” of the tree are reached. The DOM tree may be traversed using

DOM attributes to get the parents and the children of each element. Eventually, the digital signature typically has the same tree structure that the DOM element has, from the perspective of children; digital signatures 200 are typically not created for parents of each given element, but rather for each element's children.

Typically then, the system may extract element data, in a recursive manner, e.g. as per STEP 1050 also for the element's children elements and may suitably store the recursively extracted children data e.g. in an array as described below, for example, with reference to FIGS. 13a-13b. Typically although not necessarily, the children's arrays are stored in situ rather than linking them to arrays stored elsewhere, because it is advantageous for all the data for an element to be in one place from a point of view of storage and management.

The weight score for this attribute may be an aggregate score, e.g. as per step 1050 in FIG. 10, of all the children attributes in the array. An example computation is described below with reference to FIGS. 13a-13b.

Since the method may collect visibility data on elements from multiple users visiting the same page, perhaps using different rendering software and devices, the digital signature is typically distinguished such that the elements module 404 could recognize 2 or more data sets 200 referring to the same element in the page. Since the data 200 is collected regardless of how the element is rendered, it is safe for the method to assume that the same data may be generated for an element regardless of the user or the device it was rendered on. 207 is a unique ID generated (e.g. using a suitable hash function) according to certain embodiments, such that each digital signature has a unique ID which can be assumed not to be shared by any other digital signature. Server 404, then, is typically operative to aggregate all the data sets 211 and performance data 212 for the same element and store these data in only one data set 210 in the database. The unique ID may for example be generated by hashing all the data 201-206 into a unique string and, typically, appending or concatenating the URL of the webpage from which the element originated (e.g. as per Step 1060).

The reverse method to FIG. 10, then, e.g. as described herein with reference to FIG. 9, may be operative to get the digital signature 200 and find the HTML DOM element in the page based on this data. The method may use the attributes in 200 to find candidate elements and, using the weight score, may give a matching score for each of the candidate elements. A given threshold score must typically be met in order for a candidate to be a valid candidate. From all valid candidates that were found, the candidate element with the highest score may be chosen as the element matching the digital signature. In case no element was found or got a score higher than the threshold, the system may consider that the digital signature 200 was not found in this page. Due to the nature of the attributes that were taken in 200 the reverse method of FIG. 9 is typically able to find the element regardless of the position of the element in the page, the width and height of the element and where it is located in the HTML DOM structure. This typically ensures that the digital signature is unaffected by device differences or other rendering differences that may change the way the page is displayed to the user.

The method of FIG. 9, then, is operative for finding all digital signatures in a given webpage. Generally, in order to find actual elements from a digital signature, the process is to use the attributes in the digital signature to find some elements that match it. For example, given the attribute “class”, “class”=“myclass” the system may search the DOM (say) structure using a suitable DOM method such as document.querySelectorAll, or any other suitable DOM query method and gets all the elements in the page which have this class name. These elements are considered “candidates” since all of these elements have this attribute but only one of them might have all the rest of the attributes. The system identifies “candidates” based on attributes and then tries to compute for each candidate a matching score. If a predetermined success criterion is fulfilled, e.g. if a predetermined threshold is reached, then the element has been found, otherwise the method attempts to find more candidate/s based on a different attribute since it is possible that the attribute used up to now has been removed from the code.

The threshold may for example comprise a percentage, such as 75%, or any other suitable value such as 50%, 60%, 70%, 80%, 90%, 99% or any value intermediate these values, from the total score the digital signature could have. For example. if the digital signature is: [“id”,“myid”,2],[“class”,“myclass”,1][“name”,“myname”,1][“data”,“1234”,1], this means that the first is the attribute name, the second is the attribute value and the third is the weight of the attribute. Assume candidate elements as follows: <div id=“myid” class=“somclass” data=“1234”>. In this case the score of the candidate element may be 3 since the “id” is a match yielding 2 points, and the “data” match yielding an additional 1 point. so this candidate earned a score of 3 out of 5, corresponding to a 60% match rate, and therefore, if a 75% threshold is employed, the system may disqualify this candidate.

The threshold may or may not be fixed; the system may support per-site thresholds. for example, external e.g. human operator inputs may indicate that for a particular site, a current threshold is generating too many false positives (e.g. the wrong element is being identified as the searched-for element) and/or a current threshold is generating too many false negatives (e.g. the system failed to find an existing element in the webpage). In this case, the threshold for this specific site may be tweaked to reduce or eliminate such false results. The system may for example allow a default threshold to be overridden with a threshold specific to certain sites or categories of sites.

The method of FIG. 9 may include some or all of the following steps, suitably ordered e.g. as follows:

910—the method gets the array data of 210, e.g. as per FIG. 2b, for all content elements in the specific page.

920—the array is ordered by visibility data 211 such that the first element in the array is the one with the highest visibility in the page.

925—set a threshold score for this page; per-site or per-page or other differential scores may be retrieved from the server 403 or may use fixed number for all pages.

930—For each of the 210 data structure in the array of data sets of (say) FIG. 2b, the following is applied:

940—using the data set 200 the system may find one or more candidates DOM Elements in the page. The following steps 950, 960, 965 may be applied to every candidate:

950—compute match score for candidate based on each of the properties in 200. This may be done by first creating a digital signature for the candidate e.g. using the method of FIG. 10. Then, iterate over all attributes in the digital signature 200, and comparing every attribute to its matching candidate signatures. If the attribute matches, the weight of this attribute is added to the total matching score. For example, if the attribute “class” 203 has the text “myclass” and has the weight of 3, check if the candidate signature has an attribute “class” and only if its content is “myclass” the total score is increased by 3. In case of the attribute children 206 the same is done recursively to all the child digital signatures. At the end of this iteration the method has the total attributes score which is then divided by the total available score to return a match percentage. For example if total score=60 and total attributes score=100 (e.g. if 40 points were not counted since there was no match for some attributes) then the final result is 60%.

960—if the match score is higher than the threshold set in step 925, continue to step 965, else (if lower) return to step 940 with the next data item in the array.

965—if current candidate got highest score so far, mark current candidate as top candidate.

970—at the end of e.g. after looping steps 950, 960 and 965 over all candidates, the top candidate marked in 965 is considered to be the sought-for DOM element. Then return to step 940 to find another sought-after DOM element with a new item in the array of data sets of FIG. 2b e.g.

980—return output associating all content elements found in the page with their visibility measurements 211.

As shown, once steps 940-970 have been performed, the iteration to find one digital signature in the page is over and the method returns to step 940 and performs steps 940-970 again for the next digital signature to be found (for another content element on the webpage). It is appreciated that for STEP 940, any suitable operation may be employed such as but not limited to a DOM query mechanism like jquery or native API like document.querySelectorAll.

A particular advantage of the method of FIG. 9 is a person's capability of identifying a content element, even if the element or webpage or rendering thereof have been changed. For example, if a content element's location or size have changed, the person may still recognize the same content element.

The most useful attributes for this purpose are those, like id, which are unique in the webpage (<div id=“unique-id”> . . . </div>). For those content elements in which the ID attribute is lacking (e.g. has not been defined), the class attribute exists but it is not entirely unique hence a combination of class with content and/or children element characteristics is useful for this process.

The methods of FIGS. 9, 10 are generally self-explanatory, however many variations are possible. Considerations for defining importance of attributes of DOM elements are now described in detail.

Types of attributes which characterize webpage elements e.g. DOM elements typically include:

1) visual attributes—attributes which affect the visual representation of the DOM elements in the page. for example “style”,“width”, and so on.

2) action attributes—attributes which affects some user interaction or browser interaction with this element. for example “href” in an <a> tag it define the action that may happen if the user clicks on the tag. “src” is another example; in an <img> tag it defines the action that the browser may take to fetch the image.

3) data attributes—attributes which do not affect anything in the page and are only used to define data to be associated with this element. for example “id” and “class” which are browser attribute or “myownattr” which is actually a made up attribute that the developer created.

Visual and action attributes typically comprise “hard coded” attributes as defined by the browser manufacturer (e.g. Google or Microsoft), due to the effect of visual and action attributes on the actual visual or actions in the page. In contrast, some data attributes are defined by the browser while the developer of the page can create whichever data attributes he/she wants.

Typically, visual attributes are ignored by the system. It is easy to know all of them since they are documented by the browser manufacture or the W3C standards. Action attributes gets a high score since changing them leads a totally different behavior in the page. If the <img> “src” attributes are changed, a new image is obtained. With respect to data attributes, all other data attributes have the same score with the exception to the “id” which gets a high score.

For example, visual attributes to be ignored, or assigned very low weight, may include some or all of:

[“align”, “style”, “border”, “dir”, “bgcolor”, “background”, “cellpadding”, “cell spacing”, “checked”, “disabled”, “clear”, “color”, “cols ”, “colspan”, “dir”, “face”, “noresize”, “noshade”, “nowrap”, “rev”, “rows”, “rowspan”, “scrolling”, “selected”, “size”, “span”, “tabindex”, “valign”, “width”, “height”, “frameborder”, “hspace”, “marginheight”, “marginwidth”, “maxlength”, “allowfullscreen”]

Attributes to which a high score may be assigned may include some or all of: [“id”, “href”, “src”]

Attributes to which a medium or “normal” score may be assigned may include some or all of: [“class”, “name”, or whatever attributes the developer has created]

Any suitable scoring scale may be employed. For example, scores may vary from 1 to 5, where 1 is the lowest score (e.g. for a class attribute) and 5 is the highest (e.g. for an ID attribute).

It is appreciated that the more attributes the developer creates, the more tolerant the system becomes to changes in the page, since if one attribute is absent or was changed, other attributes' presence may compensate and the element may still be found, e.g.

by the method of FIG. 9, which uses whichsoever attributes are found for each element and applies weights as described above. If a developer writes no attributes at all, the content 205 and children 206 may compensate. For example, consider the following content element <p>search on <a href=http://google.com>google</a></p>. In this example the element p has no attributes at all. Therefore, if the digital signature were to be generated using only DOM attributes, the digital signature would be empty. In this case the text content of the element is “search on Google” and has a child element which has a content text of “Google” as well as an href attribute. Therefore, overall, the digital signature generated for the p element typically includes enough data to allow the reverse method (e.g. of FIG. 9) to find this element again in another version of the same webpage such as a differently rendered or slightly updated webpage.

FIG. 11 is a simplified flowchart illustration of a method for inserting an injected content into a page using the data set array 210 as returned by the injected content management module 403. The method may include some or all of the following steps, suitably ordered e.g. as follows:

1105: the method gets an array of data sets 210 for all the elements in a given page.

1107: find all elements e.g. as per method of FIG. 9

1110: sort all elements by visibility data 211 and/or

1111: sort elements by performance data 212.

1112: if method has reached the end of the array, END. Else, take next data set 210 from the array and continue to step 1114

1114: check if “ok ” to insert an injected content close to element corresponding to current data set 210. For example, if an injected content was already inserted to an element which is close to this element, it might look bad or even break the page if another injected content is inserted there as well. If the element is not valid for injected content insertion, return to 1112 and continue with next element in the array.

1116: Based on the injected content inventory (FIG. 8) try to find best injected content match to this element, e.g. taking into consideration some or all of: dimension of element, device screen resolution, dimensions of and other elements that surround it. For example, if device is mobile phone with 320 pixels width and 640 pixels height try to find mobile banner size in inventory. If no mate, go back to 1112 and continue with the next element in the array.

1118: find possible insertion method to insert the injected content close to the element. Injected content insertion types from which the system can choose from, for example, include 1) Inserting injected content before an individual element. This may cause the individual element and all elements thereafter to shift down by height of injected content inserted. 2) Inserting injected content below current element. This may cause all elements after current element to shift down according to height of content inserted. 3) Inserting content which is floating to the element. Typically possible only in text elements where content could be inserted before element and using suitable style rules (like css styling “floating:left” or “floating:right”) the injected content may be inserted according to style direction and text may wrap it. 4) Inserting content on top of element e.g. as a layer on top of the element without changing the layout of the elements at all. For example, in case of images or video elements, content could be suitably layered on top of the image.

1120: After content has been inserted into the page, check if can continue to insert injected content into the page. Stop if suitable criterion has been reached, e.g. max number of injected content items for this page, or if all elements in the array of data sets of FIG. 2b were iterated. If the criterion was not reached go back to 1112.

It is appreciated that many variations on the method of FIG. 11 are possible, as well as many different interactions with the methods shown and described above, e.g. of FIGS. 6-7, 9-10. For example:

As described above, FIG. 6 illustrates a method of collecting visibility data on content elements in a page. FIG. 2B describes the data structure to be used to track elements visibility. In order to get the visibility data (FIG. 10), the method may compute how much time each element was visible in the screen factored by some weight score of the position of the element in the screen. For example an element which is visible in the center of the screen typically gets more attention than an element which is visible on the bottom of the screen, so taking into consideration the position of the element in the screen, typically allows the method to better determine the visibility factor for each element. The position of the element in the screen is typically only used to determine its visibility factor, e.g. as described herein with reference to FIG. 5, and is not related in any way to the digital signature data 200 which is independent of the position of the element in the page. Alternatively, no visibility factor may be applied and only the time that elements are visible in the screen is computed without giving any weight to how long they were visible in each part of the screen.

In another embodiment, e.g. as described herein with reference to step 650, the system may also compute the amount of time the mouse has been over the element in the visibility data. Once the mouse is over an element, it is assumed that the user is giving this element attention and this element is visible and therefore this may be taken into consideration in the visibility data for this element with a higher priority.

Alternatively or in addition, the system may use performance data to determine the location of injected content e.g. as per step 1111 in FIG. 11. This could be used with the previous explained visibility data, or in a way which is not aware of the visibility data in any way. The system may find all the injected content already inserted to a page and may compute, e.g. as per FIG. 7, an engagement measurement of these injected content elements e.g. advertisements have and may associate this engagement data to the closest content element. This may be considered as the performance data for the content element with injected content inserted close to it. This data may allow the system to know the places where injected content were inserted e.g. as in the method of FIG. 7, those that are generating the most clicks, and therefore these places may get higher priority than other places in the page. For example, if an injected content is a banner, the system may count the number of clicks the users clicked on the banner, and in case of a video, the number of time units the video injected content was played. This data may be stored in performance data 212 and may be sent to the server and will aggregate in the same manner as 211. This may allow the system to determine from all the elements that were used to place injected content beside them, which ones are the most effective in terms of injected content engagement. Using this data, the system may be able to select the elements adjacent to which it is optimal to insert injected content, since placing injected content close to these elements is apt to generate the most user engagement.

The data in 210 is sent to a typically remote server 403, also termed herein “injected content management module 403” (FIG. 4) which aggregates e.g. as per step 660 in FIG. 6, all the visibility data 211 and performance data 212 into a singular data object 210 per element in the system. This means that all the data objects 210 from all the users are being sent to a remote server and only a single data object 210 is stored with the aggregated visibility data 211 and performance data 212 from all the users. As a result, an array of elements data 210 can be used to find and rank the most attractive elements in a page. FIG. 3 illustrates how this data can be used to rank the importance of the content elements in a page. 300 is the root content element in a given page where 301, 302, 303, 304, 305 are content elements such as text, images and video inside the content. Using the digital signature 200 the system may be able to find e.g. as per the method of FIG. 9, those elements which are associated to the digital signatures in the page and assign a rank (e.g. as per FIG. 3 and step 1110 in FIG. 11) to these elements based on the aggregated visibility data 211. Based on each element score the method may be able to sort the content elements by their visibility and/or performance data e.g. as per steps 1110 and 1111. Using the example of FIG. 3, a content element 304 might be found to be the most attractive element in the content and was ranked as number one. Content element 301 was found to be the second most attractive in the content, while content element 303 was ranked the least attractive element in the content.

Using this ranking system, the method may try to insert injected content as close as possible to the most ranked content elements in the page, e.g. as per the method of FIG. 11.

In another embodiment the system may also take into consideration the performance data 212 in order to rank the elements in the content page based on the visibility and performance data of each element. This may give a combination of two factors, the element visibility and the performance injected content get when they are placed close to this element.

In still another embodiment, the system may only use the performance data 212 to determine the rank of the content elements in the page. In this case the system may start by placing injected content close to elements by some other mechanism, such as random selection or by the order of elements appearing in the page, and start measuring the performance elements based on the engagement of the injected content close to these elements.

An example of a suitable child attribute data structure and associated aggregate score computations is now described with reference to FIGS. 13a-13b.

FIG. 13A is an example of a content element that is provided to a digital signature generator method shown and described herein e.g. as described herein with reference to FIG. 6. In the illustrated example content element 1310 is a DOM element for which it is desired to generate digital signature 200. Element 1310 is a <div> element that has 3 children elements 1321, 1322 and 1323. Child element 1323 itself has a child element 1330.

Once the digital signature has been generated for content element 1310 the structure of the data set of digital signature 200 typically appears as in FIG. 13B. The digital signature 200 for content element 1310 is represented by box 1350 in FIG. 13B.

Each of boxes 1350, 1361, 1362, 1363, 1370 are examples of digital signature data sets 200 (for the corresponding DOM elements in FIG. 13a). For example, child element 1330's digital signature is represented by box 1370. Since content element 1330 lacks children, its attributes generated an aggregated score (the sum of all the scores for all the attributes found for this element) of 10. Child 1330's parent element 1323 has a digital signature 1363 which includes content element 1323's attributes score, which is 5 in this example, and its child score which is 10. So the total score for digital signature 1363 is 15. Since both digital signatures 1361 and 1362 correspond to DOM elements which lack children, their total score is the sum of their own attribute scores, so in this example 1361 has a total score of 20 and 1362 has a total score of 15.

The aggregated score of all the attributes (excepting children) for content element 1310 itself is 10 as shown at box 1350. The aggregated score for all the child elements of content element 1310 is 50, also as shown in box 1350. Therefore, the total score of the digital signature 200 for content element 1310 is 60.

According to certain embodiments, the Digital Signature 200 of FIGS. 2a-2b may include one or both of the following attributes, in addition to some or all of the attributes shown in FIG. 2a:

a. URL—to know to which page a given digital signature belongs to. Typically, when the server 404, also termed herein “elements module 404”, asks database 405 for all the elements data 210, the page URL is provided and used for comparison to establish which data element belongs to which page. b. Text Patterns—A particular advantage of providing this attribute, according to certain embodiments, is to enhance the digital signature 200's tolerance to changes in the webpage.

A new “text patterning” method, described hereinbelow, may be employed to find a match between two texts and to provide a heuristic percentage match between them. Text patterning typically includes taking the text content for a given DOM element but rather than hashing as for attribute 205, small text samples are extracted from the text and used in a reverse method (e.g. as per FIG. 9) for comparison with candidate text patterns.

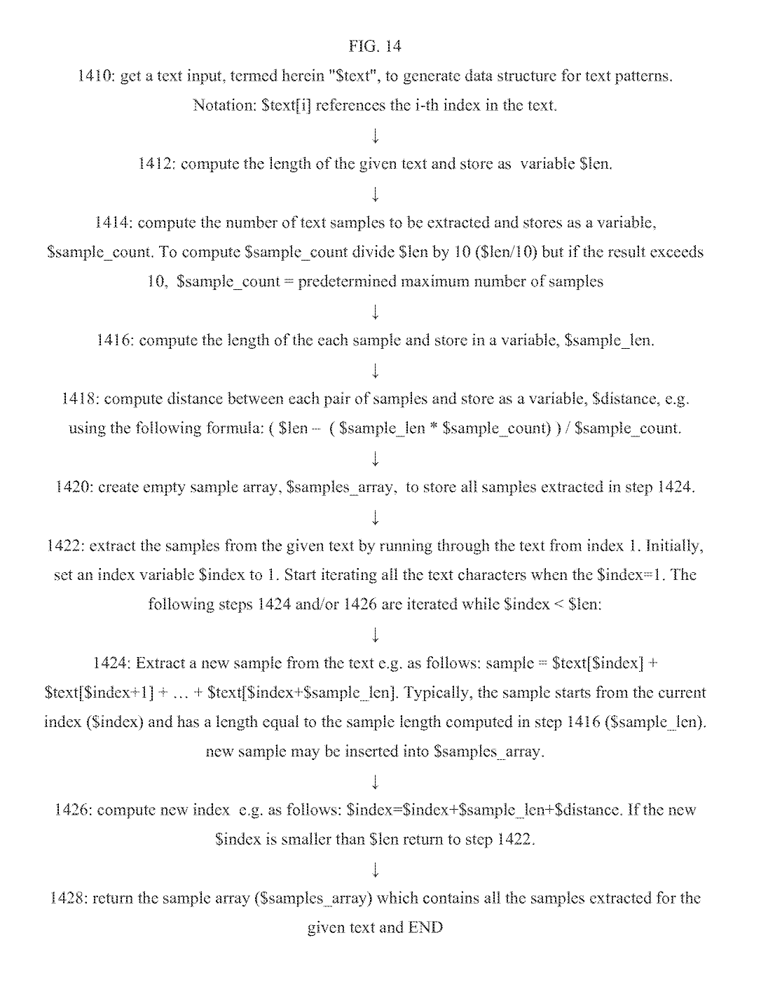

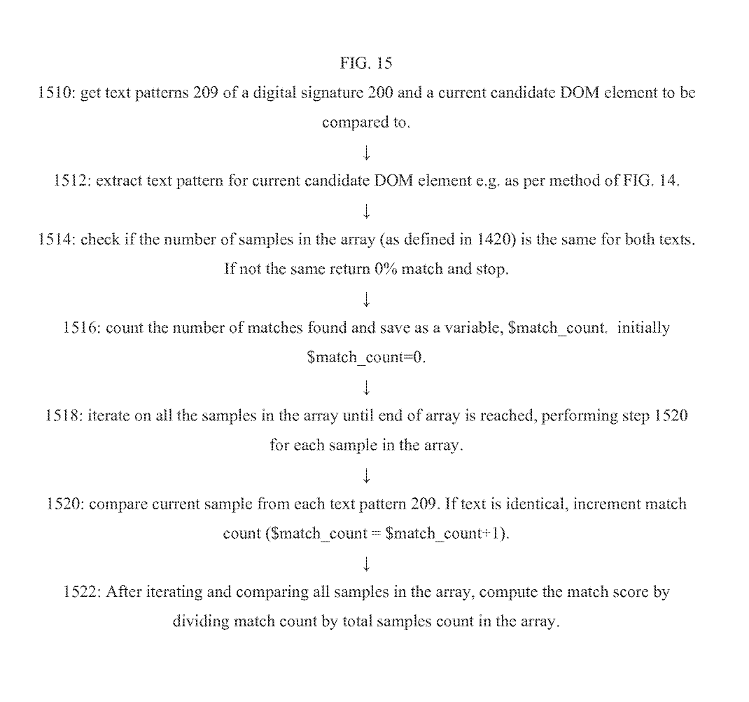

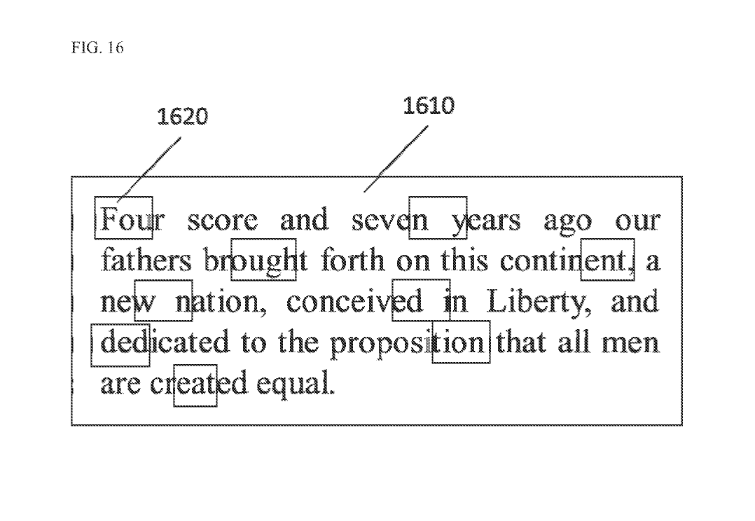

For example, as shown in FIG. 16, 1610 is a text that is being used to extract a text pattern, while 1620 is a sample from the text which, in the illustrated example, is being used to create the text pattern. All the samples in FIG. 16, such as 1620, together create the text pattern for the text 1610. A method for extracting text patterns for a given text is described herein with reference to FIG. 14. The method of FIG. 14 may for example include some or all of the following steps, suitably ordered e.g. as shown:

1410: get a text input, termed herein “$text”, to generate data structure for text patterns. Notation: $text[i] references the i-th index in the text. For example if $text=“abc” then $text[1]=“a” and $text[3]=“c”.

1412: compute the length of the given text and store as variable $len.

1414: compute the number of text samples to be extracted and stores as a variable, $sample_count. To compute $sample_count divide $len by 10 ($len/10) but if the result exceeds 10, $sample_count=10 (or some other predetermined maximum number of samples the method allows).

1416: compute the length of the each sample and store in a variable, $sample_len. For example, if $len is between 0 and 99 set $sample_len to be 3. If $len is between 100 and 999 set the $sample_len to be 4, otherwise set $sample_len to be 5.

1418: compute distance between each pair of samples and store as a variable, $distance, e.g. using the following formula: ($len−($sample_len*$sample_count))/$sample_count. For example given $len=100 and $sample_count=10 and $sample_len=4, the distance between each sample may be defined as: $distance=(100−(4*10))/10=6. The result may be rounded down to the nearest integer, e.g. if the result includes a floating point.

1420: create an empty sample array, $samples_array, to be used to contain all samples extracted in step 1424 as described below.

1422: extract the samples from the given text by running through the text from index 1. Initially, set an index variable $index to 1. Start iterating all the text characters when the $index=1. The following steps 1424 and/or 1426 are iterated while $index<$len:

1424: Extract a new sample from the text e.g. as follows: sample=$text[$index]+$text[$index+1]+ . . . +$text[$index+$sample_len]. Typically, the sample starts from the current index ($index) and has a length equal to the sample length computed in step 1416 ($sample_len). For example if $text=“abcdefg” and $index=3 and $sample_len=3 then the new sample may be “cde”. The new sample may be inserted into $samples_array.

1426: compute new index e.g. as follows:

$index=$index+$sample_len+$distance. If the new $index is smaller than $len return to step 1422.

1428: return the sample array ($samples_array) which contains all the samples extracted for the given text and END.

The result of the text pattern extraction method of FIG. 14, is typically stored as one of the attributes of digital signature 200. Text patterning is only applied, according to certain embodiments, when a given DOM element actually has text content and is always used, according to certain embodiments, when has content attribute 205 is used. The weight of the Text Patterns attribute is typically higher than the weight assigned to the hash text content attribute 205, typically by at least a factor of 2 (e.g. weight for hash text content attribute 205 is 5, weight for Text Patterns attribute is 10). This is because the text pattern is tolerant to text changes, hence performs better than attribute 205 in the event of changes in a webpage's text.

When candidates are compared with the digital signature (e.g. as per step 950 in FIG. 9), the method typically first compares the hash 205 and if there is a match, the method typically automatically assumes that the corresponding Text Patterns attribute is also a match. Typically, only if hash 205 is not a match, does the method compare the Text patterns attribute (e.g. using the method of FIG. 15) since the method assumes there is a very high chance that the text had changed in some way, and the text pattern 209 allows the method to quantify the extent of change.

The method of FIG. 15 may include some or all of the following steps, suitably ordered e.g. as shown:

1510: get text patterns 209 of a digital signature 200 and a current candidate

DOM element to be compared to.

1512: extract text pattern for current candidate DOM element e.g. as per method of FIG. 14.

1514: check if the number of samples in the array (as defined in 1420) is the same for both texts. If not, the same return 0% match and stop. This saves computation time under the assumption that if the number of samples differs between the two compared texts, the texts are different enough to justify a 0% match.

1516: count the number of matches found and save as a variable, $match_count. initially $match_count=0.

1518: iterate on all the samples in the array until end of array is reached, performing step 1520 for each sample in the array.

1520: compare current sample from each text pattern 209. If text is identical, increment match count ($match_count=$match_count+1). For example if sample 1 is “abc” and sample 2 is “abd” the samples are not identical and the match count is not increased.

1522: After iterating and comparing all samples in the array, compute the match score by dividing match count by total samples count in the array. For example if sample count=10 and there were 7 matches, return 70% match.

A particular advantage of using hash content 205 is that if the text content of the DOM element has not changed it is quicker to match the unchanged text content to the candidate hashed text content and if there is a match, it is superfluous to check for the match of the text patterns 209. Instead, the method assumes there is a full match of texts, thereby to conserve considerable processing time in the process of checking candidates against a given digital signature.

The system shown and described herein is particularly useful for processing content pages. Home pages are frequently updated with new content. In contrast, once a content page has been published on the Internet to the public domain, its content changes relatively rarely, such that for a given URL, article (or other) content is often constant, although the way that content is rendered differs from one device to another.

The system may operate as a 3rd party service in conjunction with a wide variety of legacy web/content servers, or may be integrated into web/content servers.

It is appreciated that many modifications of the example embodiment shown herein are possible. For example, regarding the example data table set of FIG. 8, which is typically used by injected content module 406 and stored in injected content database 407, it is appreciated that any other suitable data table/set may be employed alternatively, e.g. having some or all of the data fields of FIG. 8 and/or other data fields. Similarly, FIGS. 2a, 2b may include other data fields and/or may include any suitable subset of the data fields actually shown.

Another example, among many, is that the system could also work with any digital signature or any method to identify elements uniquely in a web page that facilitates both creating an identification for a content element, and, to the extent possible, allowing the element to be found in a version of the webpage, responsive to the content element's identification (signature) being presented. For example the system could work with formats which are not identical to DOM but have relevant features in common. Also, the system could also work with the W3C (World Wide Web Consortium) standard—the XPath (XML Path Language). This is a way to identify elements inside an XML document, and since HTML are a subset of XML it is valid to use xpath to identify elements in a page. The shortcoming of using this method is intolerance to page changes and updates due to reliance on the location of the element in the DOM structure. As a result, any change to the DOM structure, such as rendering the same page on a different device (e.g. mobile device instead of personal computer or vice versa) or adding/removing an image or a text to the page, breaks the xpath and makes it false. In contrast, the signature technology described herein is more robust and allows the signature to be tolerant of dynamics affecting the webpage.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present invention, inter alia, are electromagnetic signals carrying computer-readable instructions for performing any or all of the steps or operations of any of the methods shown and described herein, in any suitable order including simultaneous performance of suitable groups of steps as appropriate; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including at least one processor and/or cooperating input device and/or output device and operative to perform e.g. in software any steps shown and described herein; information storage devices or physical records, such as disks or hard drives, causing at least one computer or other device to be configured so as to carry out any or all of the steps of any of the methods shown and described herein, in any suitable order; at least one program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; at least one processor configured to perform any combination of the described steps or to execute any combination of the described modules; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The system may if desired be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Features of the present invention, including method steps, which are described in the context of separate embodiments may also be provided in combination in a single embodiment. For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including method steps, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the steps illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1. A computer-implemented method for recording content portions identified within webpages generated by each of a population of legacy websites, including, for at least one individual webpage:
identifying content portions of the individual webpage, using a processor for analyzing said content portions to determine at least one characteristic thereof other than portion location, and
storing in a computerized database, in association with the individual webpage, an indication of each of said content portions, comprising a function of the at least one characteristic.

2. The method according to claim 1 and also comprising using said indication for identifying said elements on a website page that has been altered.

3. The method according to claim 1 wherein the characteristics include at least one attribute which is unique to only one content element in a webpage.

4. The method according to claim 1 and also comprising:
identifying webpage elements having a pre-defined criterion from among said elements; and
inserting injected content adjacent said elements having said pre-defined criterion.

5. The method according to claim 1 and also comprising for each individual client device within a given group of client devices used to render said individual webpage:
using said indication for identifying said elements on at least said individual website page as rendered by said individual client device; and
identifying webpage elements having a pre-defined criterion from among elements identified at said client device and inserting content items adjacent said elements having a pre-defined criterion,
thereby to inject an individual content item at different locations in the individual webpage on different client devices, if elements are identified at different locations at different client devices due to differential rendering of the webpage to accommodate the different client devices.

6. The method according to claim 4 wherein said webpage elements having a pre-defined criterion comprise attractive webpage elements.

7. The method according to claim 4 wherein said pre-defined criterion comprises a contextual criterion.

8. The method according to claim 7 wherein said contextual criterion is defined in terms of presence of pre-selected keywords in webpage elements.

9. The method according to claim 1 wherein said function comprises a hash function.

10. The method according to claim 1 wherein said content portions are represented for recognition by a browser using a pre-defined interface.

11. The method according to claim 10 wherein said pre-defined interface is computer-platform-neutral and/or computer-language-neutral.

12. The method according to claim 10 wherein said content portions each comprise at least one DOM element.

13. The method according to claim 10 wherein said content portions each comprise exactly one DOM element.

14. The method according to claim 10 wherein said content portions each consist of an integer number of DOM elements.

15. A computer-implemented method for injecting content into webpages, the method comprising:
identifying content elements in a first rendering of an individual website page by an individual client device;
using a processor for identifying said content elements in a second rendering of said individual website page by at least one additional client device;
selecting webpage elements having a pre-defined criterion from among said content elements and inserting content items adjacent said elements having a pre-defined criterion,
thereby to systematically inject an individual content item at different locations in the individual webpage on different client devices, if elements are identified at different locations at different client devices due to differential rendering of the webpage to accommodate the different client devices.

16. The method according to claim 2 wherein said content portions comprise DOM elements, thereby to define a DOM structure for the individual webpage and said using comprises searching said DOM structure to find at least one candidate element on said individual webpage which has a first DOM element attribute corresponding to a sought-for DOM element, defining said candidate element as the sought-for element if a predetermined success criterion is fulfilled, and otherwise repeating said defining for at least one candidate element on said individual webpage which has a second DOM element attribute which differs from said first DOM element attribute.

17. The method according to claim 16 wherein said searching is performed using document.querySelectorAll.

18. The method according to claim 2 wherein said predetermined success criterion comprises reaching a threshold which is a percentage of a sum of weights, including a weight for each attribute of the sought-for DOM element, thereby to represent a maximal score of a candidate element which perfectly matches the sought-for DOM element.

19. The method according to claim 18 wherein the percentage differs predeterminedly over websites.

20. The method according to claim 4 wherein said identifying comprises determining, when a user scrolls the individual webpage, a duration of time during which each individual content portion remains in viewport, until at least one of a next scroll event and a time-out occurs, and storing said duration in association with said function of said individual content portion's characteristics.

21. The method according to claim 4 wherein said identifying comprises determining, when a user scrolls the individual webpage, a duration of time during which an input device interacts with each individual content portion, until at least one of a next scroll event and a time-out occurs, and storing said duration in association with said function of said individual content portion's characteristics.

22. The method according to claim 1 wherein said content portion has a tree structure including hierarchically related nodes and said storing includes recursively generating digital signatures for each node in said tree structure.

23. A computer program product, comprising a non-transitory tangible computer readable medium having computer readable program code embodied therein, said computer readable program code adapted to be executed to implement a method for recording content portions identified within webpages generated by each of a population of legacy websites, the method including, for at least one individual webpage:
identifying content portions of the individual webpage,
using a processor for analyzing said content portions to determine at least one characteristic thereof other than portion location, and
storing in a computerized database, in association with the individual webpage, an indication of each of said content portions, comprising a function of the at least one characteristic.

24. The method according to claim 5 wherein said webpage elements having a pre-defined criterion comprise attractive webpage elements.

25. The method according to claim 5 wherein said pre-defined criterion comprises a contextual criterion.
